(19) United States
(12) Patent Application Publication
(10) Pub. No.: US 2026/0350006 A1
(43) Pub. Date: Nov. 5, 2026

(54) DYNAMIC RETRIEVAL GRANULARITY CONTROL WITH REINFORCEMENT LEARNING FOR HYBRID RETRIEVAL-AUGMENTED GENERATION

(71) Applicant: INTERNATIONAL BUSINESS MACHINES CORPORATION, Armonk, NY (US)

(72) Inventors: Vipul MAHAJAN, Bengaluru (IN); Bharath BHUSHAN S N, Bengaluru (IN); Serge MONNEY, Pully (CH)

(21) Appl. No.: 19/194,117

(22) Filed: Apr. 30, 2025

(51) Int. Cl. G06F 16/2453

(52) U.S. Cl. CPC G06F 16/24542; G06F 16/24535

(57) ABSTRACT

Dynamic control of retrieval processing of a hybrid retrieval engine is provided by configuring an artificial intelligence system to dynamically control retrieval granularity of the hybrid retrieval engine of the artificial intelligence system to optimize retrieval processing, where the hybrid retrieval engine is a hybrid retrieval-augmented generation engine. The dynamic control of retrieval granularity includes dynamically determining, using a reinforcement machine learning model, a retrieval depth for a retrieval process of the hybrid retrieval engine based on a query, where the determining of the retrieval depth is based, at least in part, on complexity of the query to the hybrid retrieval engine. Further, the dynamic control of retrieval granularity includes dynamically applying the determined retrieval depth to the retrieval process of the hybrid retrieval engine based on the query to optimize information retrieval processing of the hybrid retrieval engine for the query.

### BACKGROUND

One or more aspects relate, in general, to enhanced computer-based information retrieval systems and methods, and more particularly, to configuring an artificial intelligence (AI) system to dynamically control retrieval granularity of a retrieval-augmented generation engine to dynamically optimize retrieval processing based on a query.

Retrieval-augmented generation (RAG) engines/systems combine the strengths of retrieval-based processing and generative models, With retrieval-augmented generation, a query or prompt is used to search a database or knowledge base for retrieval of relevant information. The retrieved information is then used to augment the context of the generative artificial intelligence (AI) model, which facilitates more accurate and appropriate responses. The augmented model then generates the final output, which is based on the generative AI model's knowledge, and the retrieved information. In this manner, retrieval-augmented generation can assist a generative artificial intelligence model in accessing current data and specific knowledge data without requiring retraining or fine tuning of the model. Retrieval-augmented generation has emerged as a pivotal advancement in generative AI, demonstrating its versatility across a wide range of industrial applications, including for question-answering and conversational use cases. While the retrieval-augmented generation architecture is widely adopted for its adaptability and cross-domain capability, there remains potential for performance enhancements.

### SUMMARY

Shortcomings of the prior art are overcome, and additional advantages are provided herein through the provision of a method which includes configuring an artificial intelligence system to dynamically control retrieval granularity of a hybrid retrieval engine of the artificial intelligence system to optimize retrieval processing, where the hybrid retrieval engine is a hybrid retrieval-augmented generation engine. The dynamic control of retrieval granularity includes dynamically determining, using a reinforcement machine learning model, a retrieval depth for a retrieval process of the hybrid retrieval engine based on a query to the hybrid retrieval engine, where the determining of the retrieval depth is based, at least in part, on complexity of the query to the hybrid retrieval engine. Further, the dynamic control of retrieval granularity includes dynamically applying the determined retrieval depth to the retrieval process of the hybrid retrieval engine based on the query to optimize information retrieval processing of the hybrid retrieval engine for the query.

Computer program products and computer systems relating to one or more aspects are also described and claimed herein. Further, services relating to one or more aspects are also described and may be claimed herein.

Additional features and advantages, such as improved retrieval efficiency, response precision, and adaptive system performance, are realized through the techniques described herein. Other embodiments are described in detail and form part of the disclosed inventive aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2 depicts one embodiment of a computer program product with dynamic retrieval granularity control code, in accordance with one or more aspects of the present disclosure;

FIG. 3 depicts one embodiment of a dynamic retrieval granularity control process, in accordance with one or more aspects of the present disclosure;

FIG. 4 depicts another example of a computing environment to include and/or use one or more aspects of the present disclosure;

FIG. 5 depicts one example of machine learning model training, in accordance with one or more aspects of the present disclosure;

FIG. 6 depicts another embodiment of a dynamic retrieval granularity control process, in accordance with one or more aspects of the present disclosure;

FIG. 7A depicts one embodiment of system-level architecture of an artificial intelligence system which includes and/or uses one or more aspects of present disclosure;

FIG. 7B depicts one embodiment of the granularity selector of FIG. 7A, acting as, or including, a reinforcement learning agent, to determine retrieval depth dynamically, in accordance with one or more aspects of the present disclosure;

FIG. 7C is an enlarged depiction of the hybrid retrieval engine and system-level feedback of FIG. 7A, in accordance with one or more aspects of the present disclosure;

FIG. 7D depicts one embodiment of a feedback loop manager of an artificial intelligence system, such as depicted in FIG. 7A, and depicts how rewards based on feedback data can be used to improve future decisions of the granularity selector, in accordance with one or more aspects of the present disclosure; and

FIG. 8 depicts one embodiment of reinforcement learning for a dynamic retrieval granularity control process, in accordance with one or more aspects of the present disclosure.

### DETAILED DESCRIPTION

Provided herein, in one or more aspects, is a method which includes configuring an artificial intelligence system to dynamically control retrieval granularity of a hybrid retrieval engine of the artificial intelligence system to optimize retrieval processing. The hybrid retrieval engine is a hybrid retrieval-augmented generation engine, and the dynamic control of retrieval granularity includes dynamically determining, using a reinforcement machine learning model, a retrieval depth for a retrieval process of the hybrid retrieval engine based on a query to the hybrid retrieval engine. The determining of the retrieval depth is based, at least in part, on complexity of the query to the hybrid retrieval engine. Further, dynamic control of retrieval granularity includes dynamically applying the determined retrieval depth to the retrieval process of the hybrid retrieval engine based on the query to optimize information retrieval processing of the hybrid retrieval engine for the query. Advantageously, the dynamic control of retrieval granularity enhances computer-based information retrieval systems and methods by dynamically configuring an artificial intelligence system to dynamically control retrieval granularity of a hybrid retrieval-augmented generation engine (or hybrid retrieval engine) for optimizing retrieval processing based on a query. In one or more embodiments, real-time adaptive retrieval depth adjustments to the hybrid retrieval engine are disclosed, which optimizes information retrieval processing of the hybrid retrieval engine. In one or more embodiments, the hybrid retrieval engine retrieval processing is dynamically adjusted between retrieval depths to ensure better overall efficiency and precision of the retrieval processing. By dynamically determining and dynamically applying a retrieval depth to the retrieval process of the hybrid retrieval engine based on the particular query, more efficient resource usage and real-time adaptation of the retrieval process are achieved.

Additionally, in one or more embodiments, the reinforcement machine learning model continues to learn and adapt in operation from feedback data, including feedback data related to the retrieval process of the hybrid retrieval engine, where the reinforcement machine learning model continues to learn and adapt from the feedback data to optimize a balance between retrieval process speed and information retrieval relevance. In embodiments, the reinforcement machine learning model continues to learn and adapt in operation from feedback data, including feedback data related to the retrieval process of the hybrid retrieval engine, to continually learn and adapt from the feedback data to optimize a balance between retrieval process speed and information retrieval relevance. Advantageously, the reinforcement machine learning model continuing to learn and adapt improves search precision, reduces computational overhead over time, and allows the model to refine retrieval decisions continuously by continually learning, which ensures that the system adapts and optimizes the retrieval process over time. The dynamic control retrieval processing is continually improving and self-optimizing the hybrid retrieval engine retrieval process.

Additionally, in one or more embodiments, the feedback data includes system-generated feedback data based on retrieval processing of the hybrid retrieval engine and user-generated feedback data based on retrieval processing results of the hybrid retrieval engine.

Advantageously, in one or more embodiments, the feedback data includes system-generated feedback data based on retrieval processing of the hybrid retrieval engine and user-generated feedback data based on retrieval processing results of the hybrid retrieval engine, which facilitates continual learning and adapting of the reinforcement machine learning model to optimize the balance between retrieval process speed and information retrieval relevance. The continual learning, in embodiments is to, optimize retrieval precision, reduce computational overhead, and improve response accuracy. Also, the continual learning advantageously takes into account both system feedback data and user feedback data to optimally refine the reinforcement machine learning model over time.

Additionally, or alternatively, in one or more embodiments, the dynamic control of retrieval granularity includes converting feedback data into numerical reward data to drive reinforcement learning updates to the reinforcement machine learning model based on the feedback data to refine retrieval granularity dynamically. In one or more embodiments, the dynamic control of retrieval granularity converts the feedback data into numerical reward data to drive the reinforcement learning updates to the reinforcement machine learning model, based on the feedback data, to refine the retrieval granularity dynamically. For example, user feedback such as clicks on relevant documents can be assigned a positive reward, while high latency or lack of user interaction can result in a negative reward; both system-level and user-level feedback data can be combined to guide the learning process. The reinforcement machine learning model continuously optimizes the balance between retrieval process and information retrieval relevance using the feedback data. The reinforcement learning updates to the reinforcement machine learning model based on the feedback data continually optimizes the dynamic control of retrieval granularity.

Additionally, or alternatively, in one or more embodiments, the dynamic control of retrieval granularity further includes data analyzing, using natural language processing, query characteristics of the query to determine the complexity of the query, where the query characteristics are selected from the group consisting of query length, query keyword density and domain-specific terms. Advantageously, in one or more embodiments, the dynamic control of retrieval granularity includes data analyzing, using natural language processing, query characteristics of the query to determine the complexity of the query, where the determined complexity of the query facilitates determining requirements of the retrieval process for the particular query to performed by the hybrid retrieval engine.

Additionally, or alternatively, in one or more embodiments, the dynamic control of retrieval granularity includes data analyzing the query to determine that the query is multi-faceted, and based on determining that the query is multi-faceted, segmenting the query into sub-queries and repeating the dynamically determining and the dynamically applying for each sub-query to optimize information retrieval processing of the hybrid retrieval engine for each sub-query. Advantageously, the data analyzing of the query to determine that the query is multi-faceted, and based on determining that the query is multi-faceted, segmenting the query into sub-queries and repeating the dynamically determining and the dynamically applying for each sub-query, provides tailored processing and optimizing of retrieval depth for each sub-query or sub-segment of the query.

Additionally, or alternatively, in one or more embodiments, dynamically determining the retrieval depth includes selecting a retrieval depth, using the reinforcement machine learning model, from the group consisting of keyword-based retrieval, semantic-based retrieval, and hybrid keyword-semantic-based retrieval. Advantageously, in embodiments, the dynamically determining of the retrieval depth includes selecting a retrieval depth, using the reinforcement machine learning model, from the group consisting of keyword-based retrieval, semantic-based retrieval, and hybrid keyword-semantic-based retrieval, which allows the dynamic control over granularity to adaptively switch or adjust between the different retrieval process strategies to, for instance, optimize information retrieval processing of the hybrid retrieval engine for the query. For instance, in one or more embodiments, dynamically adjusting retrieval depth allows more efficient resource usage, real-time adaptation of the retrieval process, and balances processing speed and response relevance for a variety of different query complexities, or types of queries.

Additionally, or alternatively, in one or more embodiments, the hybrid keyword-semantic-based retrieval includes applying keyword-based retrieval filtering followed by semantic-based retrieval filtering in the retrieval process of the hybrid retrieval engine based on the query. The hybrid keyword-semantic-based retrieval process being configured to apply keyword-based filtering followed by semantic-based retrieval filtering in the hybrid retrieval engine provides a staged retrieval process which uses, for instance, keyword filtering as an initial step to narrow the search space, followed by deeper semantic retrieval searching for improved response precision.

Additionally, or alternatively, in one or more embodiments, the dynamic control of retrieval granularity includes dynamically configuring multiple retrieval parameters for the retrieval process of the hybrid retrieval engine based on the query, where the determined retrieval depth is one retrieval parameter of the multiple retrieval parameters, and where the multiple retrieval parameters are selected from the group consisting of retrieval depth, query segmentation, retrieval process time allocation, and number of electronic documents retrieved by the retrieval process. In some embodiments, these retrieval parameters can be tuned individually or collectively by the reinforcement learning model, depending on the query context and available feedback. For instance, the model can prioritize response latency for short queries by limiting document count and time allocation, while optimizing for relevance in complex queries by increasing retrieval depth and enabling segmentation. Advantageously, in one or more embodiments, the dynamic control of retrieval granularity integrates dynamically determining and applying a retrieval depth and one or more retrieval parameters for the retrieval process to the hybrid retrieval engine based on a particular query, which facilitates optimizing information retrieval processing of the hybrid retrieval engine for the query.

In accordance with one or more aspects, each of the above-noted method embodiments is separable and optional from one another. Further, the above-noted method embodiments can be combined with one another.

In one or more other aspects, a computer program product is provided. The computer program product includes one or more computer-readable storage media and program instructions stored on the one or more computer-readable storage media to perform operations. The operations include configuring an artificial intelligence system to dynamically control retrieval granularity of a hybrid retrieval engine of the artificial intelligence system to optimize retrieval processing. The hybrid retrieval engine is a hybrid retrieval-augmented generation engine, and the dynamic control of retrieval granularity includes dynamically determining, using a reinforcement machine learning model, a retrieval depth for a retrieval process of the hybrid retrieval engine based on a query to the hybrid retrieval engine. The determining of the retrieval depth is based, at least in part, on the complexity of the query to the hybrid retrieval engine. Further, the dynamic control of retrieval granularity includes dynamically applying the determined retrieval depth to the retrieval process of the hybrid retrieval engine based on the query to optimize information retrieval processing of the hybrid retrieval engine for the query. Advantageously, the dynamic control of retrieval granularity enhances computer-based information retrieval systems and methods by dynamically configuring an artificial intelligence system to dynamically control retrieval granularity of a hybrid retrieval-augmented generation engine (or hybrid retrieval engine) for optimizing retrieval processing based on a query. In one or more embodiments, real-time adaptive retrieval depth adjustments to the hybrid retrieval engine are disclosed, which optimizes information retrieval processing of the hybrid retrieval engine. In one or more embodiments, the hybrid retrieval engine retrieval processing is dynamically adjusted between retrieval depths to ensure better overall efficiency and precision of the retrieval processing. By dynamically determining and dynamically applying a retrieval depth to the retrieval process of the hybrid retrieval engine based on the particular query, more efficient resource usage and real-time adaptation of the retrieval process are achieved.

Additionally, in one or more computer program product embodiments, the reinforcement machine learning model continues to learn and adapt in operation from feedback data, including feedback data related to the retrieval process of the hybrid retrieval engine, where the reinforcement machine learning model continues to learn and adapt from the feedback data to optimize a balance between retrieval process speed and information retrieval relevance. In embodiments, the reinforcement machine learning model continues to learn and adapt in operation from feedback data, including feedback data related to the retrieval process of the hybrid retrieval engine, to continually learn and adapt from the feedback data to optimize a balance between retrieval process speed and information retrieval relevance. Advantageously, the reinforcement machine learning model continuing to learn and adapt improves search precision, reduces computational overhead over time, and allows the model to refine retrieval decisions continuously by continually learning, which ensures that the system adapts and optimizes the retrieval process over time. The dynamic control retrieval processing is continually improving and self-optimizing the hybrid retrieval engine retrieval process.

Additionally, in one or more computer program product embodiments, the feedback data includes system-generated feedback data based on retrieval processing of the hybrid retrieval engine and user-generated feedback data based on retrieval processing results of the hybrid retrieval engine. Advantageously, in one or more embodiments, the feedback data includes system-generated feedback data based on retrieval processing of the hybrid retrieval engine and user-generated feedback data based on retrieval processing results of the hybrid retrieval engine, which facilitates continual learning and adapting of the reinforcement machine learning model to optimize the balance between retrieval process speed and information retrieval relevance. The continual learning, in embodiments is to, optimize retrieval precision, reduce computational overhead, and improve response accuracy. Also, the continual learning advantageously takes into account both system feedback data and user feedback data to optimally refine the reinforcement machine learning model over time.

Additionally, or alternatively, in one or more computer program product embodiments, the dynamic control of retrieval granularity further includes converting the feedback data into numerical reward data to drive reinforcement learning updates to the reinforcement machine learning model based on the feedback data to refine retrieval granularity dynamically. In one or more embodiments, the dynamic control of retrieval granularity converts the feedback data into numerical reward data to drive the reinforcement learning updates to the reinforcement machine learning model, based on the feedback data, to refine the retrieval granularity dynamically. In this manner, the reinforcement machine learning model continuously optimizes the balance between retrieval process and information retrieval relevance using the feedback data. The reinforcement learning updates to the reinforcement machine learning model based on the feedback data continually optimizes the dynamic control of retrieval granularity.

Additionally, or alternatively, in one or more computer program product embodiments, the dynamically determining the retrieval depth includes selecting a retrieval depth, using the reinforcement machine learning model, from the group consisting of keyword-based retrieval, semantic-based retrieval, and hybrid keyword-semantic-based retrieval. Advantageously, in embodiments, the dynamically determining of the retrieval depth includes selecting a retrieval depth, using the reinforcement machine learning model, from the group consisting of keyword-based retrieval, semantic-based retrieval, and hybrid keyword-semantic-based retrieval, which allows the dynamic control over granularity to adaptively switch or adjust between the different retrieval process strategies to, for instance, optimize information retrieval processing of the hybrid retrieval engine for the query. For instance, in one or more embodiments, dynamically adjusting retrieval depth allows more efficient resource usage, real-time adaptation of the retrieval process, and balances processing speed and response relevance for a variety of different query complexities, or types of queries.

Additionally, or alternatively, in one or more computer program product embodiments, the hybrid keyword-semantic-based retrieval includes applying keyword-based retrieval filtering followed by semantic-based retrieval filtering in the retrieval process of the hybrid retrieval engine based on the query. The hybrid keyword-semantic-based retrieval process being configured to apply keyword-based filtering followed by semantic-based retrieval filtering in the hybrid retrieval engine provides a staged retrieval process which uses, for instance, keyword filtering as an initial step to narrow the search space, followed by deeper semantic retrieval searching for improved response precision.

Additionally, or alternatively, in one or more computer program product embodiments, the dynamic control of retrieval granularity further includes dynamically configuring multiple retrieval parameters for the retrieval process of the hybrid retrieval engine based on the query, where the determined retrieval depth is one retrieval parameter of the multiple retrieval parameters, and where the multiple retrieval parameters are selected from the group consisting of retrieval depth, query segmentation, retrieval process time allocation, and number of electronic documents retrieved by the retrieval process. Advantageously, in one or more embodiments, the dynamic control of retrieval granularity integrates dynamically determining and applying a retrieval depth and one or more retrieval parameters for the retrieval process to the hybrid retrieval engine based on a particular query, which facilitates optimizing information retrieval processing of the hybrid retrieval engine for the query. These techniques collectively improve real-world system performance by reducing query response time, enhancing retrieval accuracy through context-aware depth selection, and minimizing computational overhead by dynamically adjusting retrieval parameters based on query complexity and feedback.

In accordance with one or more aspects, each of the above-noted computer program product embodiments is separable and optional from one another. Further, the above-noted computer program product embodiments can be combined with one another.

In one or more other aspects, a computer system is provided which includes a processor set, one or more computer-readable storage media, and program instructions stored on the one or more computer-readable storage media to cause the processor set to perform operations. The operations include configuring an artificial intelligence system to dynamically control retrieval granularity of a hybrid retrieval engine of the artificial intelligence system to optimize retrieval processing. The hybrid retrieval engine is a hybrid retrieval-augmented generation engine, and the dynamic control of retrieval granularity includes dynamically determining, using a reinforcement machine learning model, a retrieval depth for a retrieval process of the hybrid retrieval engine based on a query to the hybrid retrieval engine, where the determining of the retrieval depth is based, at least in part, on complexity of the query to the hybrid retrieval engine. Further, the dynamic control of retrieval granularity includes dynamically applying the determined retrieval depth to the retrieval process of the hybrid retrieval engine based on the query to optimize information retrieval processing of the hybrid retrieval engine for the query. Advantageously, the dynamic control of retrieval granularity enhances computer-based information retrieval systems and methods by dynamically configuring an artificial intelligence system to dynamically control retrieval granularity of a hybrid retrieval-augmented generation engine (or hybrid retrieval engine) for optimizing retrieval processing based on a query. In one or more embodiments, real-time adaptive retrieval depth adjustments to the hybrid retrieval engine are disclosed, which optimizes information retrieval processing of the hybrid retrieval engine. In one or more embodiments, the hybrid retrieval engine retrieval processing is dynamically adjusted between retrieval depths to ensure better overall efficiency and precision of the retrieval processing. By dynamically determining and dynamically applying a retrieval depth to the retrieval process of the hybrid retrieval engine based on the particular query, more efficient resource usage and real-time adaptation of the retrieval process are achieved.

Additionally, in one or more computer system embodiments, the reinforcement machine learning model continues to learn and adapt in operation from feedback data, including feedback data related to the retrieval process of the hybrid retrieval engine, where the reinforcement machine learning model continuing to learn and adapt from the feedback data optimizes a balance between retrieval process speed and information retrieval relevance. In embodiments, the reinforcement machine learning model continues to learn and adapt in operation from feedback data, including feedback data related to the retrieval process of the hybrid retrieval engine, to continually learn and adapt from the feedback data to optimize a balance between retrieval process speed and information retrieval relevance. Advantageously, the reinforcement machine learning model continuing to learn and adapt improves search precision, reduces computational overhead over time, and allows the model to refine retrieval decisions continuously by continually learning, which ensures that the system adapts and optimizes the retrieval process over time. The dynamic control retrieval processing is continually improving and self-optimizing the hybrid retrieval engine retrieval process.

Additionally, or alternatively, in one or more computer system embodiments, the feedback data includes system-generated feedback data based on retrieval processing of the hybrid retrieval engine and user-generated feedback data based on retrieval processing results of the hybrid retrieval engine. Advantageously, in one or more embodiments, the feedback data includes system-generated feedback data based on retrieval processing of the hybrid retrieval engine and user-generated feedback data based on retrieval processing results of the hybrid retrieval engine, which facilitates continual learning and adapting of the reinforcement machine learning model to optimize the balance between retrieval process speed and information retrieval relevance. The continual learning, in embodiments is to, optimize retrieval precision, reduce computational overhead, and improve response accuracy. Also, the continual learning advantageously takes into account both system feedback data and user feedback data to optimally refine the reinforcement machine learning model over time.

Additionally, or alternatively, in one or more computer system embodiments, the dynamic control of retrieval granularity further includes converting the feedback data into numerical reward data to drive reinforcement learning updates to the reinforcement machine learning model based on the feedback data to refine retrieval granularity dynamically. In one or more embodiments, the dynamic control of retrieval granularity converts the feedback data into numerical reward data to drive the reinforcement learning updates to the reinforcement machine learning model, based on the feedback data, to refine the retrieval granularity dynamically. In this manner, the reinforcement machine learning model continuously optimizes the balance between retrieval process and information retrieval relevance using the feedback data. The reinforcement learning updates to the reinforcement machine learning model based on the feedback data continually optimizes the dynamic control of retrieval granularity.

In accordance with one or more aspects, each of the above-noted computer system embodiments is separable and optional from one another. Further, the above-noted computer system embodiments can be combined with one another.

In accordance with one or more further aspects, a method is provided which includes configuring an artificial intelligence system to dynamically control retrieval granularity of a hybrid retrieval engine of the artificial intelligence system to optimize retrieval processing. The hybrid retrieval engine is a hybrid retrieval-augmented generation engine, and the dynamic control of retrieval granularity includes dynamically determining, using a reinforcement machine learning model, a retrieval depth for a retrieval process of the hybrid retrieval engine based on a query to the hybrid retrieval engine. The determining of the retrieval depth is based, at least in part, on complexity of the query to the hybrid retrieval engine. Further, dynamic control of retrieval granularity includes dynamically applying the determined retrieval depth to the retrieval process of the hybrid retrieval engine based on the query to optimize information retrieval processing of the hybrid retrieval engine for the query. In embodiments, the reinforcement machine learning model continues to learn and adapt in operation from feedback data, including feedback data related to the retrieval process of the hybrid retrieval engine, where the reinforcement machine learning model continues to learn and adapt from the feedback data to optimize a balance between retrieval process speed and information retrieval relevance. In embodiments, the dynamic control of retrieval granularity further includes data analyzing, using natural language processing, query characteristics of the query to determine the complexity of the query, where the query characteristics are selected from the group consisting of query length, query keyword density and domain-specific terms. Advantageously, the dynamic control of retrieval granularity enhances computer-based information retrieval systems and methods by dynamically configuring an artificial intelligence system to dynamically control retrieval granularity of a hybrid retrieval-augmented generation engine (or hybrid retrieval engine) for optimizing retrieval processing based on a query. In one or more embodiments, real-time adaptive retrieval depth adjustments to the hybrid retrieval engine are disclosed, which optimizes information retrieval processing of the hybrid retrieval engine. In one or more embodiments, the hybrid retrieval engine retrieval processing is dynamically adjusted between retrieval depths to ensure better overall efficiency and precision of the retrieval processing. By dynamically determining and dynamically applying a retrieval depth to the retrieval process of the hybrid retrieval engine based on the particular query, more efficient resource usage and real-time adaptation of the retrieval process are achieved. In embodiments, the reinforcement machine learning model continues to learn and adapt in operation from feedback data, including feedback data related to the retrieval process of the hybrid retrieval engine, to continually learn and adapt from the feedback data to optimize a balance between retrieval process speed and information retrieval relevance. Advantageously, the reinforcement machine learning model continuing to learn and adapt improves search precision, reduces computational overhead over time, and allows the model to refine retrieval decisions continuously by continuously learning, which ensures that the system adapts and optimizes the retrieval process over time. The dynamic control retrieval processing is continually improving and self-optimizing the hybrid retrieval engine retrieval process. In one or more embodiments, the dynamic control of retrieval granularity includes data analyzing, using natural language processing, query characteristics of the query to determine the complexity of the query, where the determined complexity of the query facilitates determining requirements of the retrieval process for the particular query to performed by the hybrid retrieval engine.

In accordance with one or more further aspects, a method is provided which includes configuring an artificial intelligence system to dynamically control retrieval granularity of a hybrid retrieval engine of the artificial intelligence system to optimize retrieval processing. The hybrid retrieval engine is a hybrid retrieval-augmented generation engine, and the dynamic control of retrieval granularity includes dynamically determining, using a reinforcement machine learning model, a retrieval depth for a retrieval process of the hybrid retrieval engine based on a query to the hybrid retrieval engine. The determining of the retrieval depth is based, at least in part, on complexity of the query to the hybrid retrieval engine. Further, dynamic control of retrieval granularity includes dynamically applying the determined retrieval depth to the retrieval process of the hybrid retrieval engine based on the query to optimize retrieval processing of the hybrid retrieval engine for the query. In embodiments, the reinforcement machine learning model continues to learn and adapt in operation from feedback data, including feedback data related to the retrieval process of the hybrid retrieval engine, where the reinforcement machine learning model continues to learn and adapt from the feedback data to optimize a balance between retrieval process speed and information retrieval relevance. The dynamically determining the retrieval depth includes selecting a retrieval depth, using the reinforcement machine learning model, from the group consisting of keyword-based retrieval, sematic-based retrieval, and hybrid keyword-semantic-based retrieval. The hybrid keyword-semantic-based retrieval includes applying keyword-based retrieval filtering followed by semantic-based retrieval filtering in the retrieval process of the hybrid retrieval engine based on the query. Advantageously, the dynamic control of retrieval granularity enhances computer-based information retrieval systems and methods by dynamically configuring an artificial intelligence system to dynamically control retrieval granularity of a hybrid retrieval-augmented generation engine (or hybrid retrieval engine) for optimizing retrieval processing based on a query. In one or more embodiments, real-time adaptive retrieval depth adjustments to the hybrid retrieval engine are disclosed, which optimizes information retrieval processing of the hybrid retrieval engine. In one or more embodiments, the hybrid retrieval engine retrieval processing is dynamically adjusted between retrieval depths to ensure better overall efficiency and precision of the retrieval processing. By dynamically determining and dynamically applying a retrieval depth to the retrieval process of the hybrid retrieval engine based on the particular query, more efficient resource usage and real-time adaptation of the retrieval process are achieved. In embodiments, the reinforcement machine learning model continues to learn and adapt in operation from feedback data, including feedback data related to the retrieval process of the hybrid retrieval engine, to continually learn and adapt from the feedback data to optimize a balance between retrieval process speed and information retrieval relevance. Advantageously, the reinforcement machine learning model continuing to learn and adapt improves search precision, reduces computational overhead over time, and allows the model to refine retrieval decisions continuously by continuously learning, which ensures that the system adapts and optimizes the retrieval process over time. The dynamic control retrieval processing is continually improving and self-optimizing the hybrid retrieval engine retrieval process. In embodiments, the dynamically determining of the retrieval depth includes selecting a retrieval depth, using the reinforcement machine learning model, from the group consisting of keyword-based retrieval, semantic-based retrieval, and hybrid keyword-semantic-based retrieval, which allows the dynamic control over granularity to adaptively switch or adjust between the different retrieval process strategies to, for instance, optimize information retrieval processing of the hybrid retrieval engine for the query. For instance, in one or more embodiments, dynamically adjusting retrieval depth allows more efficient resource usage, real-time adaptation of the retrieval process, and balances processing speed and response relevance for a variety of different query complexities, or types of queries. The hybrid keyword-semantic-based retrieval process being configured to apply keyword-based filtering followed by semantic-based retrieval filtering in the hybrid retrieval engine provides a staged retrieval process which uses, for instance, keyword filtering as an initial step to narrow the search space, followed by deeper semantic retrieval searching for improved response precision.

In accordance with one or more further aspects, a method is provided which includes configuring an artificial intelligence system to dynamically control retrieval granularity of a hybrid retrieval engine of the artificial intelligence system to optimize retrieval processing. The hybrid retrieval engine is a hybrid retrieval-augmented generation engine, and the dynamic control of retrieval granularity includes dynamically determining, using a reinforcement machine learning model, a retrieval depth for a retrieval process of the hybrid retrieval engine based on a query to the hybrid retrieval engine. The determining of the retrieval depth is based, at least in part, on complexity of the query to the hybrid retrieval engine. Further, dynamic control of retrieval granularity includes dynamically applying the determined retrieval depth to the retrieval process of the hybrid retrieval engine based on the query to optimize retrieval processing of the hybrid retrieval engine for the query. In embodiments, the reinforcement machine learning model continues to learn and adapt in operation from feedback data, including feedback data related to the retrieval process of the hybrid retrieval engine, where the reinforcement machine learning model continues to learn and adapt from the feedback data to optimize a balance between retrieval process speed and information retrieval relevance. In one or more embodiments, the dynamically determining the retrieval depth includes selecting a retrieval depth, using the reinforcement machine learning, from the group consisting of keyword-based retrieval, semantic-based retrieval and hybrid keyword-semantic-based retrieval. Further, the dynamic control of retrieval granularity includes dynamically configuring multiple retrieval parameters for the retrieval process of the hybrid retrieval engine based on the query, where the determined retrieval depth is one retrieval parameter of the multiple retrieval parameters, and where the multiple retrieval parameters are selected from the group consisting of retrieval depth, query segmentation, retrieval process time allocation, and number of electronic documents retrieved by the retrieval process. Advantageously, the dynamic control of retrieval granularity enhances computer-based information retrieval systems and methods by dynamically configuring an artificial intelligence system to dynamically control retrieval granularity of a hybrid retrieval-augmented generation engine (or hybrid retrieval engine) for optimizing retrieval processing based on a query. In one or more embodiments, real-time adaptive retrieval depth adjustments to the hybrid retrieval engine are disclosed, which optimizes information retrieval processing of the hybrid retrieval engine. In one or more embodiments, the hybrid retrieval engine retrieval processing is dynamically adjusted between retrieval depths to ensure better overall efficiency and precision of the retrieval processing. By dynamically determining and dynamically applying a retrieval depth to the retrieval process of the hybrid retrieval engine based on the particular query, more efficient resource usage and real-time adaptation of the retrieval process are achieved. In embodiments, the reinforcement machine learning model continues to learn and adapt in operation from feedback data, including feedback data related to the retrieval process of the hybrid retrieval engine, to continually learn and adapt from the feedback data to optimize a balance between retrieval process speed and information retrieval relevance. Advantageously, the reinforcement machine learning model continuing to learn and adapt improves search precision, reduces computational overhead over time, and allows the model to refine retrieval decisions continuously by continuously learning, which ensures that the system adapts and optimizes the retrieval process over time. The dynamic control retrieval processing is continually improving and self-optimizing the hybrid retrieval engine retrieval process. Advantageously, in embodiments, the dynamically determining of the retrieval depth includes selecting a retrieval depth, using the reinforcement machine learning model, from the group consisting of keyword-based retrieval, semantic-based retrieval, and hybrid keyword-semantic-based retrieval, which allows the dynamic control over granularity to adaptively switch or adjust between the different retrieval process strategies to, for instance, optimize information retrieval processing of the hybrid retrieval engine for the query. For instance, in one or more embodiments, dynamically adjusting retrieval depth allows more efficient resource usage, real-time adaptation of the retrieval process, and balances processing speed and response relevance for a variety of different query complexities, or types of queries. Advantageously, in one or more embodiments, the dynamic control of retrieval granularity integrates dynamically determining and applying a retrieval depth and one or more retrieval parameters for the retrieval process to the hybrid retrieval engine based on a particular query, which facilitates optimizing information retrieval processing of the hybrid retrieval engine for the query.

In accordance with one or more further aspects, a method is provided which includes configuring an artificial intelligence system to dynamically control retrieval granularity of a hybrid retrieval engine of the artificial intelligence system to optimize retrieval processing. The hybrid retrieval engine is a hybrid retrieval-augmented generation engine, and the dynamic control of retrieval granularity includes dynamically determining, using a reinforcement machine learning model, a retrieval depth for a retrieval process of the hybrid retrieval engine based on a query to the hybrid retrieval engine. The determining of the retrieval depth is based, at least in part, on complexity of the query to the hybrid retrieval engine. Further, dynamic control of retrieval granularity includes dynamically applying the determined retrieval depth to the retrieval process of the hybrid retrieval engine based on the query to optimize retrieval processing of the hybrid retrieval engine for the query. In embodiments, the reinforcement machine learning model continues to learn and adapt in operation from feedback data, including feedback data related to the retrieval process of the hybrid retrieval engine, where the reinforcement machine learning model continuing to learn and adapt from the feedback data optimizes a balance between retrieval process speed and information retrieval relevance. In embodiments, the dynamic control of retrieval granularity includes data analyzing the query to determine that the query is multi-faceted, and based on the determining that the query is multi-faceted, segmenting the query into sub-queries and repeating the dynamically determining and the dynamically applying for each sub-query to optimize information retrieval processing of the hybrid retrieval engine for each sub-query. In one or more embodiments, the dynamically determining the retrieval depth includes selecting a retrieval depth, using the reinforcement machine learning model, from the group consisting of keyword-based retrieval, sematic-based retrieval, and hybrid keyword-sematic-based retrieval. Advantageously, the dynamic control of retrieval granularity enhances computer-based information retrieval systems and methods by dynamically configuring an artificial intelligence system to dynamically control retrieval granularity of a hybrid retrieval-augmented generation engine (or hybrid retrieval engine) for optimizing retrieval processing based on a query. In one or more embodiments, real-time adaptive retrieval depth adjustments to the hybrid retrieval engine are disclosed, which optimizes information retrieval processing of the hybrid retrieval engine. In one or more embodiments, the hybrid retrieval engine retrieval processing is dynamically adjusted between retrieval depths to ensure better overall efficiency and precision of the retrieval processing. By dynamically determining and dynamically applying a retrieval depth to the retrieval process of the hybrid retrieval engine based on the particular query, more efficient resource usage and real-time adaptation of the retrieval process are achieved. In embodiments, the reinforcement machine learning model continues to learn and adapt in operation from feedback data, including feedback data related to the retrieval process of the hybrid retrieval engine, to continually learn and adapt from the feedback data to optimize a balance between retrieval process speed and information retrieval relevance. Advantageously, the reinforcement machine learning model continuing to learn and adapt improves search precision, reduces computational overhead over time, and allows the model to refine retrieval decisions continuously by continuously learning, which ensures that the system adapts and optimizes the retrieval process over time. The dynamic control retrieval processing is continually improving and self-optimizing the hybrid retrieval engine retrieval process. Advantageously, the data analyzing of the query to determine that the query is multi-faceted, and based on determining that the query is multi-faceted, segmenting the query into sub-queries and repeating the dynamically determining and the dynamically applying for each sub-query, provides tailored processing and optimizing of retrieval depth for each sub-query or sub-segment of the query. Advantageously, in embodiments, the dynamically determining of the retrieval depth includes selecting a retrieval depth, using the reinforcement machine learning model, from the group consisting of keyword-based retrieval, semantic-based retrieval, and hybrid keyword-semantic-based retrieval, which allows the dynamic control over granularity to adaptively switch or adjust between the different retrieval process strategies to, for instance, optimize information retrieval processing of the hybrid retrieval engine for the query. For instance, in one or more embodiments, dynamically adjusting retrieval depth allows more efficient resource usage, real-time adaptation of the retrieval process, and balances processing speed and response relevance for a variety of different query complexities, or types of queries.

Methods, computer program products, and computer systems relating to one or more aspects are described and claimed herein. Each of the embodiments of the methods can be embodiments of a computer program product and/or computer system, and vice versa. Further, each of the embodiments are separable and optional from one another. Moreover, embodiments can be combined with one another. Each of the method embodiments can be combined with aspects and/or embodiments of one or more of the computer program products and/or computer systems, and vice versa.

Aspects of the present disclosure and certain features, advantages, and details thereof, are explained more fully below with reference to the non-limiting example(s) illustrated in the accompanying drawings. Descriptions of well-known software, systems, devices, processing techniques, models, tools, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, tools, engines, etc. One or more aspects of an illustrative embodiment can be implemented in software, hardware, or a combination thereof.

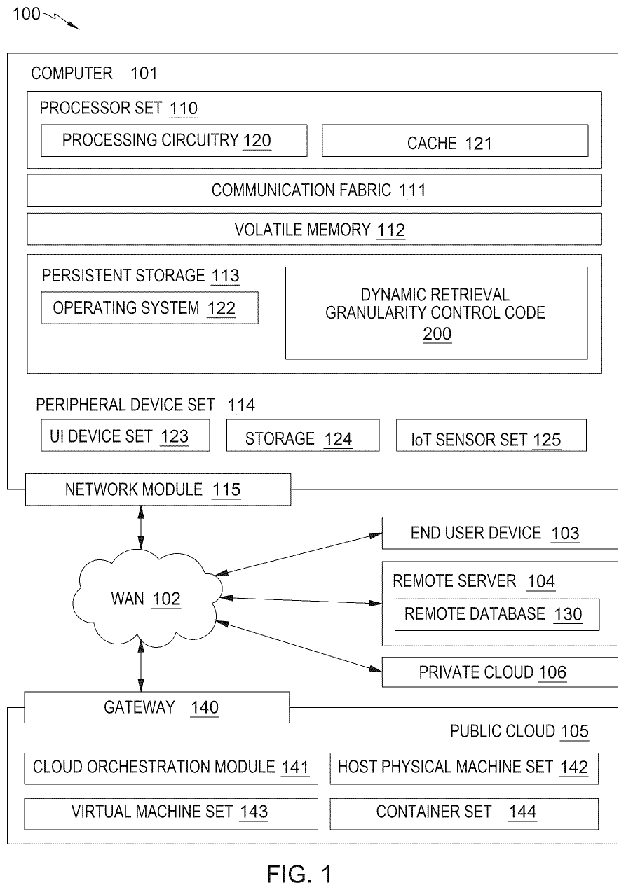

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as code, or one or more programs, are depicted in FIG. 1, including operating system 122 and dynamic retrieval granularity control code 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform processing, such as disclosed herein. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As illustrated in FIG. 1, computing environment 100 contains an example of an environment for the execution of at least some of the computer code involved in performing the inventive methods, such as dynamic retrieval granularity control code 200. In addition to code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in dynamic retrieval granularity control code 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

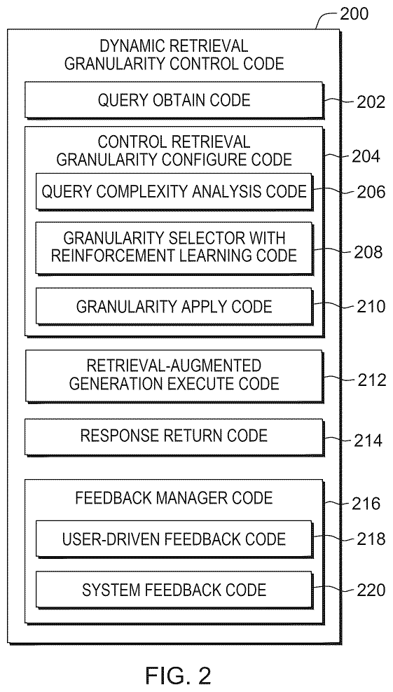

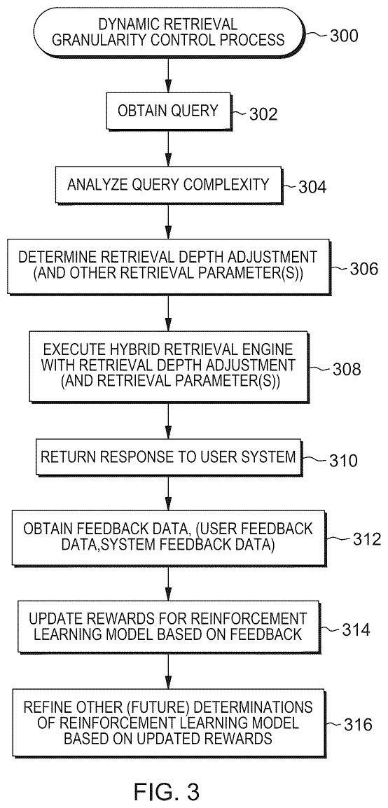

By way of example, embodiments of the dynamic retrieval granularity control code and the dynamic retrieval granularity control process are described initially with reference to FIGS. 2-3. FIG. 2 depicts one embodiment of dynamic retrieval granularity control code 200 that includes code or instructions (e.g., of one or more artificial intelligence systems) to perform dynamic retrieval granularity control processing, in accordance with one or more aspects of the present disclosure, and FIG. 3 depicts one embodiment of a dynamic retrieval granularity control process workflow, in accordance with one or more aspects of present disclosure.

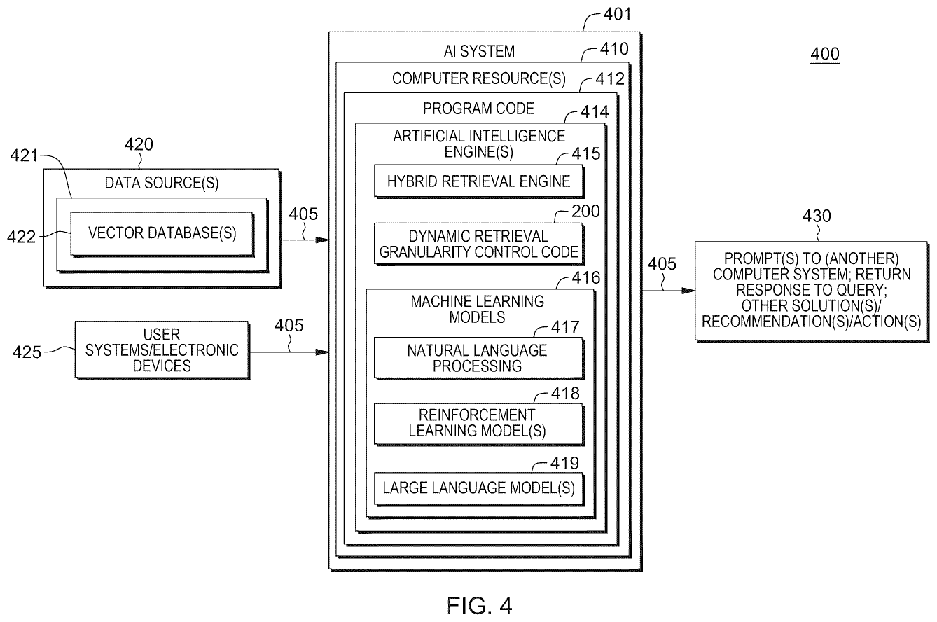

Referring to FIGS. 1-2, dynamic retrieval granularity control code 200 includes, in one example, various code or sub-modules used to perform processing, in accordance with one or more aspects of present disclosure. The sub-modules are, e.g., computer-readable program code (e.g., instructions) in computer-readable media (e.g. persistent storage 113, such as a disk) and/or cache (e.g., cache 121) as examples). The computer-readable media can be part of one or more computer program products and can be executed by and/or using one or more computers, such as computer(s) 101 (FIG. 1), and/or one or more artificial intelligence (AI) systems (e.g., artificial intelligence system 401 (FIG. 4)), etc., one or more processor sets 110 (FIG. 1), processors, such as one or more processors of processor set 110, and/or processing circuitry, such as processing circuitry of processor set 110, etc.

As noted, FIG. 2 depicts one embodiment of dynamic retrieval granularity control code 200 which, in one or more implementations, dynamically facilitates or enhances, one or more computer processes of a computing environment, in accordance with one or more aspects of present disclosure. As depicted in FIG. 2, in one or more embodiments, dynamic retrieval granularity control code 200 includes query obtain code 202 to obtain one or more queries for a hybrid retrieval engine of an artificial intelligence system, in accordance with one or more aspects of present disclosure, where the hybrid retrieval engine is a hybrid retrieval-augmented generation engine which is controllable to perform keyword-based retrieval searching, semantic-based retrieval searching, or hybrid keyword-semantic-based retrieval searching combining both keyword-based retrieval searching and semantic-based retrieval searching. In general, keyword-based retrieval searching is a fast, but shallow search, while semantic-based retrieval searching is a deep, but resource intensive retrieval search. Advantageously, pursuant to the dynamic retrieval granularity control disclosed herein, the hybrid retrieval engine is dynamically, proactively controlled (e.g., switched, adjusted, etc.) between these approaches before the retrieval happens, providing fast, resource-efficient results to a particular query, without compromising relevance or depth of the search.

In one or more embodiments, dynamic retrieval granularity control code 200 further includes control retrieval granularity configure code 204 which, for instance, facilitates configuring, or configures, the artificial intelligence system with dynamic, proactive control of retrieval granularity of the hybrid retrieval engine to optimize retrieval processing. Advantageously, control retrieval granularity configure code 204 allows the artificial intelligence system to dynamically adjust retrieval strategies, or processing, in real-time, ensuring efficient use of resources and highly-relevant results for both simple and complex queries to the hybrid retrieval engine. In one or more embodiments, control retrieval granularity configure code 204 includes query complexity analysis code 206 to implement adaptive complexity analysis. In one or more embodiments, query complexity analysis code 206 evaluates one or more attributes of a query, such as query length, query structure, domain-specific terminology, etc., to obtain query complexity data to, at least in part, guide the dynamic retrieval granularity control of the retrieval process. For instance, in one or more embodiments, control retrieval granularity configure code 204 operates to adjust the retrieval process dynamically before retrieval-augmented generation, thereby optimizing retrieval depth in real-time. Disclosed herein is a dynamic retrieval granularity control code and process which tunes the retrieval process depth based, at least in part, on query complexity. In one or more implementations, simple queries can receive quick, lightweight responses from the hybrid retrieval engine, while more complex queries can trigger deeper, more refined retrieval process searches.

In one or more embodiments, control retrieval granularity configure code 204 also includes granularity selector with reinforcement learning code 208 to dynamically, proactively determine, using a reinforcement machine learning model or agent, an optimal retrieval depth for the retrieval process of the hybrid retrieval engine based on the query to the hybrid retrieval engine. Advantageously, the integration of reinforcement learning into the dynamic retrieval granularity control allows the system to learn and optimize retrieval decisions continuously, improving efficiency over time. In embodiments, determining the retrieval depth by the granularity selector (GS) with reinforcement learning (RL) is based, at least in part, on the analyzed complexity of the query. For instance, in one or more embodiments, the granularity selector with reinforcement learning code 208 acts, in part, as a reinforcement learning agent, and dynamically, proactively selects retrieval depth (e.g., shallow (keyword-based), intermediate (hybrid keyword-semantic-based), deep (semantic-based)) for searching based on the query complexity, as well as, for instance, current system conditions and historical system performance. Note that as used herein “retrieval depth” for a retrieval process of the hybrid retrieval engine refers to selecting a particular retrieval depth strategy, such as a selection among predefined retrieval strategies, including keyword-based retrieval processing, semantic-based retrieval processing, and/or hybrid keyword-semantic-based retrieval processing.

In one or more embodiments, control retrieval granularity configure code 204 further includes granularity apply code 210 to proactively apply the dynamically determined retrieval depth to the retrieval process of the hybrid retrieval engine based on the query to optimize the information retrieval processing of the hybrid retrieval engine for the query. As disclosed, in one or more embodiments, the hybrid retrieval engine is a hybrid retrieval-augmented generation engine that is dynamically switched between, for instance, a keyword-based retrieval process strategy, a semantic-based retrieval process strategy and a hybrid keyword-semantic-based retrieval process strategy to enhance system retrieval processing efficiency and system response precision for a variety of queries of different complexity.

In one or more embodiments, dynamic retrieval granularity control code 200 further includes retrieval-augmented generation execute code 212 to, for instance, initiate, or facilitate, execution of the hybrid retrieval engine using the dynamically controlled, and proactively adjusted, retrieval granularity, and in particular, the applied retrieval depth, for the retrieval process of the hybrid retrieval engine based on the particular query, where the dynamic control of retrieval granularity optimizes information retrieval processing of the hybrid retrieval engine for the query by providing fast, resource-efficient results without comprising relevance or depth. In one or more embodiments, dynamic retrieval granularity control code 200 further includes response return code 214 to return a response of the hybrid retrieval engine retrieval process based on the query using the applied retrieval depth.

Further, in one or more embodiments, dynamic retrieval granularity control code 200 includes feedback manager code 216 which includes, in one or more embodiments, user-driven feedback code 218 and system feedback code 220 to, for instance, capture user and/or system feedback data, such as, user click-through rates, system processing latency data, system response latency data, response relevance data, etc., to dynamically refine the reinforcement learning model of, or associated with, the granularity selector with reinforcement learning, and thereby continuously refine the retrieval depth decisions being generated by the reinforcement learning model for the granularity selector. In this manner, the real-time feedback of user and system related data enhances retrieval efficiency, precision, and system resource management through continual learning by the reinforcement model. For instance, the dynamic retrieval granularity control code 200 implements return of real-time feedback to the feedback manager code, such as user response interaction data and system metric data, to refine the machine learning model strategies, ensuring that the dynamically determined retrieval depth for a particular retrieval process of the hybrid retrieval engine remains relevant and efficient even in high load environments. Further, note that in one or more embodiments, the dynamic retrieval granularity control code can be implemented as part of a distributed computing environment to facilitate asynchronous pre-fetching and adaptive resource allocation to handle large scale operations. Further, user-driven feedback code can be configured to receive user personalization data to, for instance, adjust retrieval strategies to user-specific needs, thereby further enhancing user satisfaction with the dynamic retrieval granularity control with reinforcement learning process disclosed.

Note that although various code or sub-modules are described herein, dynamic retrieval granularity control code, such as disclosed, can use, or include, additional, fewer, and/or different code/sub-modules. A particular code can include additional code, including code of other sub-modules, or less code. Further, additional and/or fewer code/sub-modules can be used. Many variations are possible.

In one or more embodiments, the dynamic retrieval granularity control code is used, in accordance with one or more aspects of the present disclosure, to perform or implement dynamic retrieval granularity control processing. By way of example, FIG. 3 depicts one embodiment of a dynamic retrieval granularity control process 300, such as disclosed herein. The process is executed, in one or more embodiments, by one or more computers (e.g. computer 101 (FIG. 1), one or more artificial intelligence (AI) systems (e.g., artificial intelligence system 401 (FIG. 4)), and/or one or more processor sets, such as a processor or processing circuitry (e.g., of processor set 110 of FIG. 1). In one example, code or instructions implementing the process, are part of a code or module, such as dynamic retrieval granularity control code 200 of FIGS. 1-2. In other examples, the code can be included in one or more other modules and/or one or more other sub-modules of the one or more modules. Various options are available.

In one or more embodiments, dynamic retrieval granularity control process 300 (FIG. 3) executes on one or more computers (e.g., computer 101 of FIG. 1, artificial intelligence (AI) system 401 (FIG. 4), and/or one or more processor sets (e.g., processor set 110 of FIG. 1, such as a processor or processing circuitry of the processor set)) and performs processing such as disclosed herein, which includes, in one or more aspects, obtaining one or more queries 302, such as one or more queries from a user system or user electronic device. In embodiments, the obtained query is analyzed for query complexity 304, such as by a query complexity analyzer which evaluates query attributes to facilitate determining parameters of the retrieval process, including, for instance, a retrieval depth for the retrieval process of the hybrid retrieval engine. For instance, in one or more embodiments, the query complexity analyzer is configured to evaluate query characteristics, keyword density, and domain-specific terminology, to determine the complexity of the query. Further, for multi-faceted queries, the analyzer segments the queries into sub-queries, enabling tailored processing and optimizing of retrieval depth for each query segment. In one or more embodiments, dynamic retrieval granularity control process 300 further includes determining a retrieval depth adjustment and optionally one or more retrieval parameters 306 for the retrieval process responsive to the query. In embodiments, determining the retrieval depth adjustment is performed by a granularity selector with reinforcement learning, as disclosed herein. The granularity selector dynamically, proactively selects a retrieval process strategy (e.g., shallow, intermediate or deep) based on system feedback data (e.g., latency data, resource usage data, etc.) and based on user data, such as, for instance, user response satisfaction score data. In one specific embodiment, the reinforcement learning-based granularity adjustment model can be based on Q-learning to refine its retrieval strategies over time. For instance, in one or more embodiments, the reinforcement learning implements, or is based on, a reinforcement machine learning model which assigns Q-values to retrieval actions, optimizing a balance between retrieval speed, depth and relevance.

In one or more embodiments, dynamic retrieval granularity control process 300 further includes executing the hybrid retrieval engine, with the retrieval depth adjustment (and any other dynamically specified retrieval parameters such as disclosed herein) being proactively applied to the retrieval process 308 to generate a response to the obtained query, and with the response being returned to the user system 310. In one or more embodiments, the hybrid retrieval engine executes the retrieval process or actions as determined by the granularity selector with reinforcement learning. In this manner, the hybrid retrieval engine processing combines, for instance, keyword-based retrieval (for speed and simplicity), semantic-based retrieval (for depth and contextual accuracy) and/or a hybrid combination of both, depending on the particular query complexity and context as recommended by the reinforcement learning. In a hybrid retrieval process, the hybrid retrieval engine implements a staged retrieval process where, for instance, a keyword-based search can be used to narrow the scope, before a deeper, semantic-based retrieval search is implemented based on the narrowed search scope. In one or more embodiments, the hybrid retrieval engine can be configured to use one or more pre-trained models for the semantic searches, and support switching between and/or combining retrieval methods based on query complexity, as disclosed herein.

As depicted, in one or more embodiments, dynamic retrieval granularity control process 300 further includes obtaining feedback data, including implicit or explicit user feedback data and/or system metrics feedback data 312. For instance, in one or more embodiments, the feedback loop manager code or facility obtains user and system feedback data, such as response relevance data, response precision data, process latency data, user click-through rate data, etc., which is used, in one or more embodiments, to continually refine subsequent retrieval decisions by the granularity selector with reinforcement machine learning. For instance, in one or more embodiments, dynamic retrieval granularity control process 300 includes updating rewards for the reinforcement learning model, associated with, or used by, the granularity selector, based on obtained feedback data 314. In this manner, the reinforcement learning model, or reinforcement machine learning model, continually learns and adapts from the feedback data to, for instance, optimize balancing retrieval process performance, or speed, and information retrieval relevance. Advantageously, the process continuously learns and optimizes the best retrieval strategies for particular queries or query types. Further, the dynamic retrieval granularity control process 300 includes, in one or more embodiments, refining other (e.g., future) determinations of the reinforcement learning model based on the updated rewards 316, thereby continually learning and optimizing the retrieval process strategies over time. In this manner, the dynamic retrieval granularity control process can efficiently handle an array of diverse query complexities by balancing retrieval speed, resource consumption and query relevance for the different query complexities to ensure that the artificial intelligence system proactively adapts and optimizes the determined retrieval depth, and/or other retrieval parameters, used by the hybrid retrieval engine based on the particular query. Further, in one or more embodiments, the dynamic retrieval granularity control process can facilitate implementing distributed computing for handling large-scale queries by distributing retrieval tasks across multiple nodes. Also, asynchronous pre-fetching can be used to anticipate deeper retrieval needs for complex queries to reduce latency of the retrieval process. In one or more embodiments, the dynamic retrieval granularity control with reinforcement learning can be deployed to, or be executed within, a cloud-based computing environment, for instance, to handle diverse query loads. Further, the dynamic control of retrieval granularity disclosed can be integrated into existing retrieval-augmented generation (RAG) systems to improve adaptability, scalability, and efficiency in the existing systems. In one or more embodiments, the reinforcement learning model can be trained with an initial dataset of user queries and feedback data, with the retrieval processing strategies being refined over time based on subsequent feedback data obtained from the user system and/or the artificial intelligence system.

By way of further example, FIG. 4 depicts another embodiment of a computing environment 400, which can incorporate, use and/or implement, one or more aspects of an embodiment of the present disclosure. In one or more embodiments, computing environment 400 is implemented as part of, or includes, a computing environment such as computing environment 100 described above in connection with FIG. 1. In one or more implementations, computing environment 400 includes an artificial intelligence (AI) system 401 with one or more computer resource(s) 410, such as one or more computers 101 of FIG. 1, connected across a network 405 to receive (e.g., obtain, access, etc.) data from one or more data sources 420, such as one or more vector databases 421 to be referenced by, for instance, a hybrid retrieval engine 415 of artificial intelligence system 401. Note that in one or more embodiments, hybrid retrieval engine 415 is, or includes, a hybrid retrieval-augmented generation engine or system that enhances a generative artificial intelligence model by incorporating information retrieved from one or more sources, such as data sources 420, including, for instance, one or more vector database(s) 421, to improve accuracy and context of the generated response. Note also that although depicted in FIG. 4 as part of a separate data source, in one or more other embodiments, data source(s) 420, and in particular, vector database(s) 421 can be associated with, or be part, artificial intelligence system 401. In one or more embodiments, one or more user systems/electronic devices 425 operatively couple to artificial intelligence system 401 via one or more networks 405 to, for instance, submit queries to the artificial intelligence system, and/or receive responses from the system. Further, user systems/electronic devices 425 can be used, for instance, to implicitly, or explicitly generate user feedback data based on one or more returned responses to one or more user queries 430. In addition, in one or more embodiments, user systems/electronic devices 425 can be used to provide preference data to artificial intelligence system 401, for instance, to further customize the hybrid retrieval engine processing to a particular user's preference(s), as disclosed herein.

In embodiments, the computer resource(s) 410 of AI system 401 executes program code 412 that runs or implements, for instance, one or more artificial intelligence engines 414 that execute, or include, one or more aspects of dynamic retrieval granularity control code 200 and dynamic retrieval granularity control process 300 (FIG. 3), such as disclosed herein. As depicted, in one or more embodiments, artificial intelligence engine(s) 414 includes, for instance, dynamic retrieval granularity control code 200 and a hybrid retrieval engine 415, such as a hybrid retrieval-augmented generation engine adapted to facilitate dynamic control of retrieval granularity, in accordance with one or more aspects of the present disclosure. In one or more embodiments, dynamic retrieval granularity control code 200 includes, utilizes and/or trains one or more machine learning models 416, which can be part of dynamic retrieval granularity control code 200 or accessed by dynamic retrieval granularity control code 200. In one or more embodiments, machine learning models 416 include, for instance, one or more natural language processing models 417, one or more reinforcement learning models 418, one or more large language models 419, and/or other machine learning models used to implement, or facilitate, one or more aspects of the processing disclosed herein. In one or more embodiments, artificial intelligence engine 414 facilitates training one or more machine learning model(s) 416, such as to perform one or more aspects of the dynamic retrieval granularity control processing disclosed. As discussed, artificial intelligence system 401, and in particular, artificial intelligence engine 414, is programmed to facilitate dynamically controlling retrieval granularity of the hybrid retrieval engine 415 to optimize retrieval processing.

As noted, in one or more embodiments, the artificial intelligence engine 414 includes dynamic retrieval granularity control code 200 which implements, and/or uses, in one or more embodiments, dynamic retrieval granularity control for optimizing information retrieval of the hybrid retrieval engine. In one or more embodiments, a granularity selector with reinforcement learning model is leveraged to dynamically, proactively adjust a retrieval depth and one or more other retrieval parameters based, at least in part, on real-time query complexity analysis, as well as user and/or system feedback data. In embodiments, the dynamic retrieval granularity control efficiently balances retrieval depth, resource management, and query complexity by fine tuning parameters, such as number of retrieval layers (e.g., layer 1 (keyword-based retrieval), layer 2 (hybrid-based retrieval) or layer 3 (semantic-based retrieval)), processing time allocation, and/or number of documents retrieved. In one or more embodiments, the artificial intelligence system integrates, or includes, keyword-based retrieval processing, sematic-based retrieval processing, as well as hybrid keyword-semantic-based retrieval processing, and is highly scalable, adaptable to evolving query patterns, and can be personalized to user preferences. In embodiments, the dynamic retrieval granularity control implemented by artificial intelligence engine(s) 414 facilitates dynamically adjusting the retrieval depth of the retrieval process, with the reinforcement learning and granularity selector being continually dynamically adjusted through real-time feedback (i.e., based on user feedback data and/or system feedback data), thereby overcoming limitations of static retrieval systems, and resulting in retrieval of results, chunks of data, etc., with good relevance scores, and reduced system retrieval processing overhead.

In one or more embodiments, artificial intelligence engine 414 executes, or initiates executing, dynamic retrieval granularity control code 200 which includes, or references, one or more machine learning models to implement the noted computer processing, which can include, for instance, obtaining a query from a user system and dynamically adjusting retrieval granularity in the hybrid retrieval engine based, at least in part, on the obtained query. In one or more embodiments, the adjusting retrieval granularity employs adaptive strategies driven by reinforcement learning to optimize, for instance, the retrieval depth, processing time allocation, number of documents retrieved, etc., for the query. In one or more embodiments, the dynamic retrieval granularity control process includes analyzing query complexity and dynamically, proactively adapting retrieval parameters to enhance, or optimally balance, processing efficiency, response relevance and system resource utilization. For instance, in one or more embodiments, the process includes determining a retrieval depth adjustment, and any other desired retrieval parameters, based on the analyzed query complexity using a reinforcement learning model. In one or more embodiments, the retrieval depth and/or retrieval parameters are adjusted iteratively to ensure precision and efficiency of the dynamic retrieval granularity control process. As noted, one or more embodiments, the reinforcement learning model is updated based on feedback data, such as implicit or explicit user feedback data and/or system feedback data, to facilitate balancing exploration of new retrieval strategies with exploitation of optimized retrieval strategies, such as, for instance, using an epsilon-greedy policy.

In one or more embodiments, the dynamic retrieval granularity processing of the artificial intelligence system includes, for instance, returning a response to the query to the user system, as well as one or more other intermediate or output solutions/recommendations/actions based on the particular application of the artificial intelligence system 430. The other solutions/recommendations/actions can include, for instance, providing one or more prompts to another system such as to facilitate one or more aspects of the dynamic retrieval granularity control processing and/or one or more aspects of one or more computer processes facilitated by the dynamic retrieval granularity control process. In one or more embodiments, artificial intelligence engine 414 can also generate intermediate prompts to, for instance, one or more of natural language processing 417, reinforcement learning model 418, and/or large language model processing 419, either within the artificial intelligence system 401 or external to the artificial intelligence system (in another embodiment) to facilitate performing one or more processes of the dynamic retrieval granularity control processing disclosed.

In one or more implementations, computing environment 400 can include, or utilize, one or more internal and/or external networks 405 for interfacing various aspects of computer resource(s) 410, data source(s) 420, as well as one of or more other controllers, components, systems, etc., receiving a prompt, result, action, instruction etc. 430 of the dynamic retrieval granularity control code 200, and/or artificial intelligence system 401, in a manner that facilitates the improved computer-based system processing disclosed herein. By way of example, the network(s) can be, for instance, a telecommunications network, a local area network (LAN), a wide area network (WAN), such as the Internet, or a combination thereof, and can include wired, wireless, fiber optic connections, etc. The network(s) can include one or more wired and/or wireless networks that are capable of receiving and/or transmitting electronic query-related data, including (for instance) training data for one or more of the machine learning model(s) of, or used by, the artificial intelligence system such as disclosed herein, and an output solution, recommendation, or action of the dynamic retrieval granularity control code 200, and/or artificial intelligence system 401, such as discussed.

In one or more implementations, computer resource(s) 410 house and/or execute program code 412 configured to perform computer-implemented methods in accordance with one or more aspects of the present disclosure. By way of example, computer resource(s) 410 can be a computing-system-implemented resource(s). Further, for illustrative purposes only, computer resource(s) 410 in FIG. 4 is depicted as being a single computer resource. This is a non-limiting example of an implementation. In one or more other embodiments, computer resource(s) 410, which implements one or more aspects of processing such as discussed herein, can, at least in part, be implemented in multiple separate computer resources or systems, such as one or more computer resources of a cloud-hosting environment, by way of example.

Briefly described, in one embodiment, computer resource(s) 410 can include one or more processor sets with one or more processors, for instance, central processing units (CPUs). Also, the processor set(s) can include functional components used in the integration of program code, such as functional components to fetch program code from locations in memory, such as cache or main memory, decode program code, and execute program code, access memory for instruction execution, and write results of the executed instructions or code. The processor set(s) can also include a register(s) to be used by one or more of the functional components. In one or more embodiments, the computing resource(s) can include memory, input/output, a network interface, and storage, which can include and/or access, one or more other computing resources and/or databases, as required to implement the dynamic retrieval granularity control code processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computer resource(s), or computing system(s) or controller(s), which can implement one or more aspects disclosed are described further herein.

In one or more embodiments, program code 412 includes, executes, accesses, etc., artificial intelligence engine 414, with dynamic retrieval granularity control code 200, and which can train and/or use machine learning models 415 that embody (in part), or are used by, the dynamic retrieval granularity control code 200. The artificial intelligence engine 414 can be (in part) one or more artificial intelligence (AI) agents or AI tools and/or can include, or use, one or more machine learning models that are pretrained using training data that can include a variety of types of electronic query and response data, as well as electronic feedback data, etc. In one or more embodiments, program code 412 executing on one or more computer resources 410 applies one or more algorithms of, for instance, the artificial intelligence engine 414 to generate and train the machine learning model(s) 415, which the program code then utilizes to, for instance, implement one or more aspects of dynamic retrieval granularity control code 200. In an initialization or learning stage, program code 412 can train the one or more machine learning models 415 using an obtained training dataset to implement, for instance, one or more aspects of the code, functions and/or tools described herein.

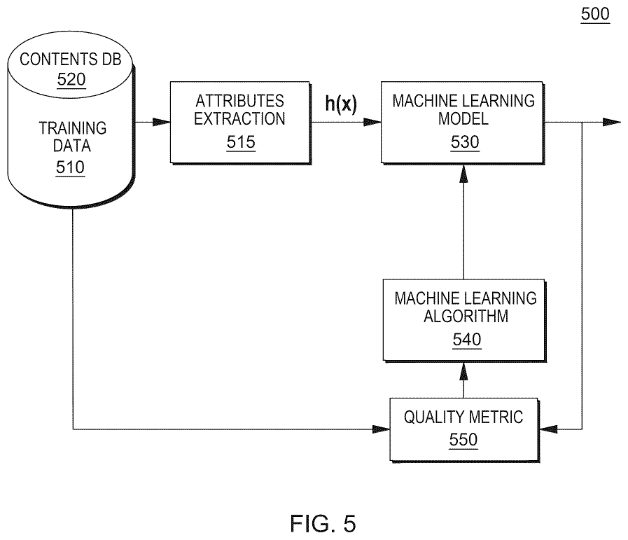

One example of a machine learning training system is depicted in FIG. 5. In one or more embodiments, a machine learning training system 500 can be utilized to perform cognitive analysis of various inputs, including input data, data from one or more sources, repositories, data structures and/or other data. The data can include query descriptions, feature weights, electronic documents, feedback data, etc., such as described herein. Program code, in embodiments of the present disclosure, can perform data analysis to generate data structures, including algorithms utilized by the program code to implement one or more aspects of the dynamic retrieval granularity control processing and/or initiate (or perform) an action related thereto. As known, machine learning-based modeling solves problems that cannot be solved by numerical means alone. In one example, program code extracts features/attributes 515 from the training data 510, which can be stored in memory or one or more databases 520. The extracted features can be utilized to develop a predictor function, h(x), also referred to as a hypothesis, which the program code utilizes as a model 530.

In identifying various event states, features, attribute similarities, constraints and/or behaviors indicative of states in the ML training data 510, the program code can utilize various techniques to identify attributes in an embodiment of the present disclosure. Embodiments of the present disclosure utilize varying techniques to select attributes (data attributes, elements, patterns, features, constraints, distribution, etc.), including but not limited to, diffusion mapping, principal component analysis, recursive feature elimination (a brute force approach to selecting attributes), and/or a Random Forest, to select the attributes related to various events. The program code may utilize a machine learning algorithm 540 to train the machine learning model(s) 530 (e.g., the algorithms utilized by the program code), including providing weights for the conclusions, so that the program code can train the predictor functions that comprise the machine learning model(s) 530. The conclusions may be evaluated by a quality metric 550. By selecting a diverse set of ML training data 510, the program code trains the machine learning model(s) 530 to identify and weight various attributes (e.g., data attributes, features, patterns, constraints, distributions, etc.) that correlate to various states or events of a process.

The model generated by the program code can be self-learning or reinforcing, since in one or more embodiments, the program code can update the model based on feedback data, such as from, or based on, user feedback data and/or system feedback data. For example, when the program code determines that there is a response, constraint, event, similarity or pattern (e.g., data attribute, record attribute similarity, query pattern, data distribution, search terms distribution, etc.) that was not previously predicted by the model, the program code can utilize a learning agent to update the model to reflect the state of the event, in order to improve predictions in the future. Additionally, when the program code determines that a prediction is incorrect, either based on receiving user feedback through an interface or based on monitoring system feedback data, the program code can update the model to reflect the inaccuracy of the model results. Program code including a learning agent cognitively analyzes any data deviating from the modeled expectations and adjusts the model to increase the accuracy of the model, moving forward. Advantageously, the reinforcement learning model disclosed herein continues to learn and adapt in operation from feedback data, including feedback data related to the retrieval process of the hybrid retrieval engine, with, for instance, the reinforcement learning model continuing to learn and adapt from the feedback data to optimize a balance between retrieval process speed and information retrieval relevance.

In one or more embodiments, the program code can utilize one or more neural networks (NNs) to, for instance, analyze training data and/or collected data to generate an operational machine learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present disclosure, can utilize in implementing a machine learning model, such as described herein.

As noted initially, retrieval-augmented generation (RAG) engines/systems combine the strengths of retrieval-based processing and generative models. With retrieval-augmented generation, a query or prompt is used to search a database or knowledge base for retrieval of relevant information. The retrieved information is then used to augment the context of the generative artificial intelligence (AI) model, which facilitates more accurate and appropriate responses. The augmented model then generates the final output, which is based on the generative AI model's knowledge, and the retrieved information. In this manner, retrieval-augmented generation can assist a generative artificial intelligence model in accessing current data and specific knowledge data without requiring retraining or fine tuning of the model.

Retrieval-augmented generation has emerged as a pivotal advancement in generative AI, demonstrating its versatility across a wide range of industrial applications, including for question-answering and conversational use cases. While the retrieval-augmented generation architecture is widely adopted for its adaptability and cross-domain capability, there remains potential for performance enhancements or optimizations.

Many existing retrieval-augmented generation-based search and retrieval systems suffer from static retrieval configurations, which can lead to one or more of: over-retrieval of an excessive number of results, and often irrelevant results (e.g., irrelevant documents); under-retrieval of results; retrieving insufficient context for complex queries, where fixed hyperparameter settings can increase resource consumption; and/or inefficient search adaptation, where the search and retrieval system fails to dynamically adjust to varying query complexities. For instance, conventional retrieval-augmented generation systems often apply fixed retrieval strategies that do not dynamically adapt to the complexity or intent of the query. This can lead to inefficiencies in retrieval depth, overuse of computational resources, or underperformance in response quality. Accordingly, there remains a need for systems and methods that enable real-time, query-aware adjustment of retrieval strategies, particularly through reinforcement learning or other adaptive mechanisms. As noted, shortcomings of the prior art are addressed herein through a method for dynamically controlling retrieval granularity in a hybrid retrieval-augmented generation engine. The method includes using a reinforcement learning model to determine an appropriate retrieval depth based at least in part on the complexity of a received query. The determined retrieval depth is then applied to the retrieval process to optimize information retrieval performance. This dynamic, query-aware adjustment improves over static retrieval configurations used in conventional systems.

More particularly, in one or more aspects, disclosed herein are methods, computer program products and computer systems which include, or utilize, dynamic retrieval granularity control code and/or processing that proactively configures an artificial intelligence system to dynamically control retrieval granularity of a hybrid retrieval engine (i.e., a hybrid retrieval-augmented generation engine) of an artificial intelligence system to optimize retrieval processing for a particular query. As disclosed herein, in one or more embodiments, an adaptive retrieval mechanism is presented that dynamically, proactively adjusts retrieval depth based on real-time query complexity and feedback data. By leveraging reinforcement learning, the artificial intelligence system continuously optimizes retrieval precision, reduces computational overhead, and improves response accuracy. As disclosed herein, reinforcement learning is utilized for dynamic hyperparameter tuning in a hybrid retrieval engine or system, enabling real-time adaptive retrieval depth adjustments. Traditional retrieval-augmented generation (RAG) models rely on fixed or manually tuned retrieval settings, leading to inefficiencies in search precision and computational overhead. In one or more embodiments, disclosed herein is a granularity selector that includes, or references, a reinforcement learning model or agent, to dynamically adjust retrieval depth (e.g., shallow (keyword-based), intermediate (hybrid-based), or deep (semantics-based)) based, at least in part, on query complexity, as well as current system load, user feedback data, etc. Additionally, a hybrid retrieval engine is disclosed which optimizes retrieval strategies by dynamically switching between, for instance, keyword-based retrieval processing, semantic-based retrieval processing and hybrid keyword-semantic-based retrieval processing. In one or more embodiments, the system optimizes retrieval decisions overtime by continually learning through a feedback loop manager process, to for instance, learning to reduce resource consumption, while continually improving response relevance. In addition, in one or more embodiments, the artificial intelligence system can be configured to refine retrieval process results by incorporating, for instance, user preferences. Further, by leveraging reinforcement learning, real-time feedback, and hybrid retrieval strategies, the dynamic retrieval granularity control processing enables the artificial intelligence system to deliver scalable, efficient, and adaptive solutions, ensuring optimal query processing across diverse workloads.

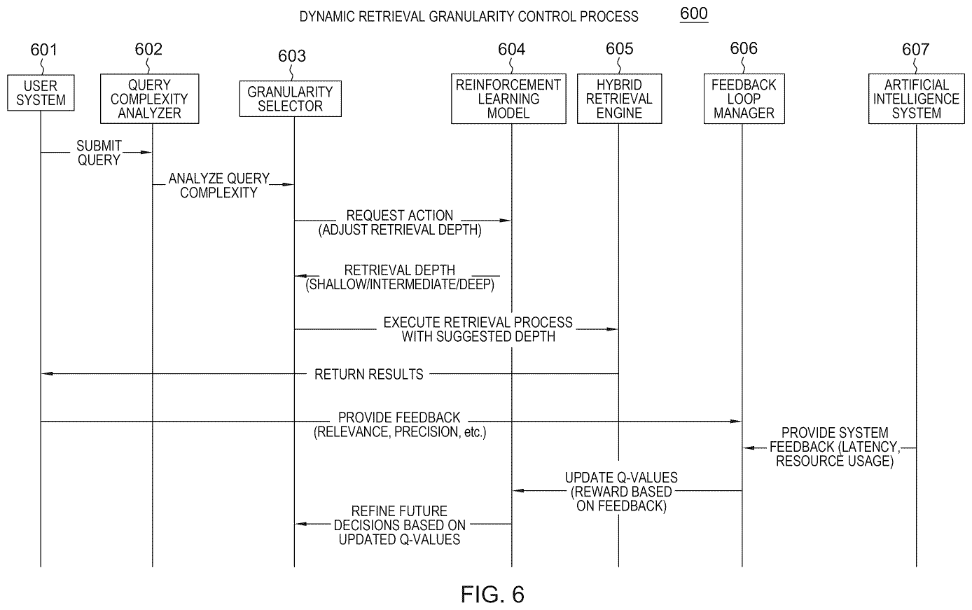

FIG. 6 depicts another embodiment of a dynamic retrieval granularity control process 600, in accordance with one or more aspects of the present disclosure. In one or more embodiments, dynamic retrieval granularity control process 600 is the same as, or similar to, the above-described dynamic retrieval granularity control processing of FIG. 3. As illustrated, in one embodiment, a user system 601 submits a query to a query complexity analyzer 602. In one or more embodiments, query complexity analyzer 602 is, or includes, an adaptive query complexity analysis process which evaluates query attributes, such as query length, query structure, query-domain specific terminology, etc., to determine retrieval process requirements. The query complexity analyzer forwards the analyzed query complexity to a granularity selector 603 which references, is associated with, or includes, a reinforcement learning model 604, or reinforcement machine learning model, as disclosed herein.

As illustrated, in one or more embodiments, granularity selector 603 requests an action from the reinforcement learning model 604, such as a recommendation to adjust the retrieval depth for the query. In one or more embodiments, the reinforcement learning model 604 functions as a reinforcement learning agent to dynamically select a retrieval depth (e.g., shallow, intermediate, deep) based on query complexity, as well as, for instance, system conditions and/or historical performance. A suggested retrieval depth for the retrieval process of the hybrid retrieval engine based on the query is returned by the reinforcement learning model 604 to the granularity selector 603. In one or more embodiments, granularity selector 603 initiates execution of the retrieval process of the hybrid retrieval engine 605 using the suggested retrieval depth. In this manner, the hybrid retrieval engine can be dynamically switched or adjusted between, for instance, keyword-based retrieval processing, semantic-based retrieval processing and hybrid keyword-semantic-based retrieval processing to ensure enhanced efficiency and precision.

As illustrated in FIG. 6, hybrid retrieval engine 605 returns a response (or result) to the user system 601 in reply to the query. In one or more embodiments, dynamic retrieval granularity control process 600 further includes a feedback loop manager 606, which in one or more embodiments, receives user feedback data from user system 601 to the provided retrieval response from the hybrid retrieval engine 605. Additionally, or alternatively, system feedback data is received from the artificial intelligence system 607 including, or using, hybrid retrieval engine 605. For instance, in one or more embodiments, user feedback data can include response relevance data, response precision data, user click-through rate data, etc., and system feedback data can include, for instance, system latency data, resource usage data, etc. In one or more embodiments, feedback loop manager 606 processes the user feedback data and/or system feedback data to obtain a reward value based on the feedback. For instance, in one or more embodiments, the reinforcement learning model is, or implements, a Q-learning model that allows the model to learn an optimal policy or response by iteratively updating a table of Q-values, which represent the respective cumulative reward for taking a specific action at a given state. In one or more embodiments, the feedback loop manager generates a reward Q-value that is then updated in the Q-table of the reinforcement learning model 604. In one or more embodiments, reinforcement learning model 604 can use the Q-values and an epsilon-greedy strategy to balance exploring new retrieval processes and exploiting optimized retrieval processes. In this manner, future decisions of the granularity selector are continually refined by the reinforcement learning model through use of the updated reward values, or updated Q-values.

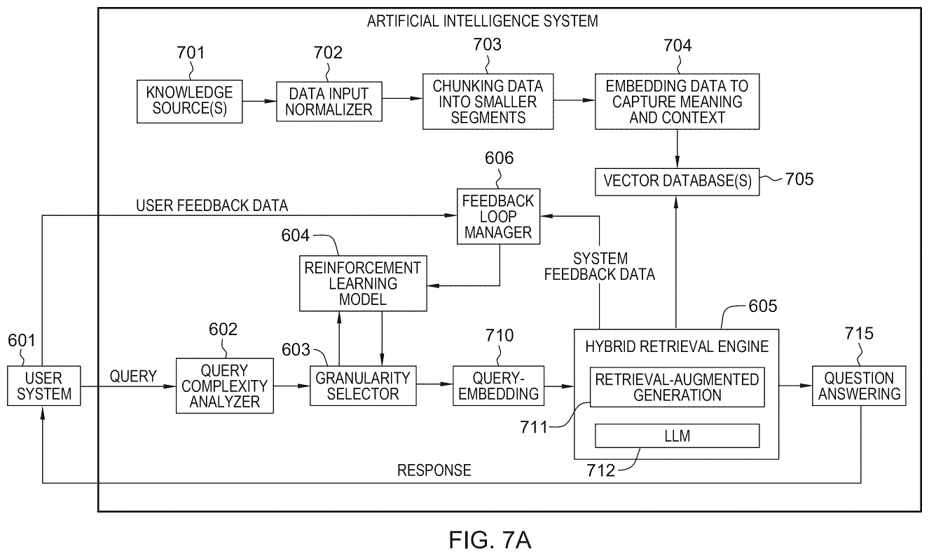

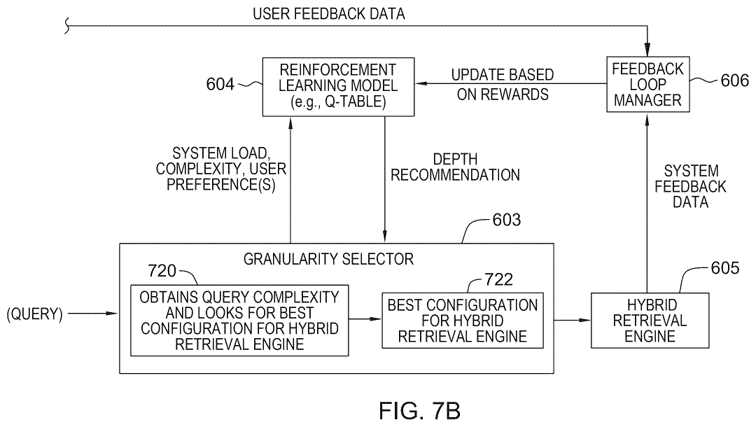

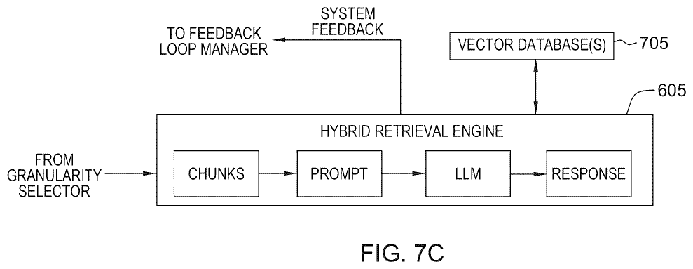

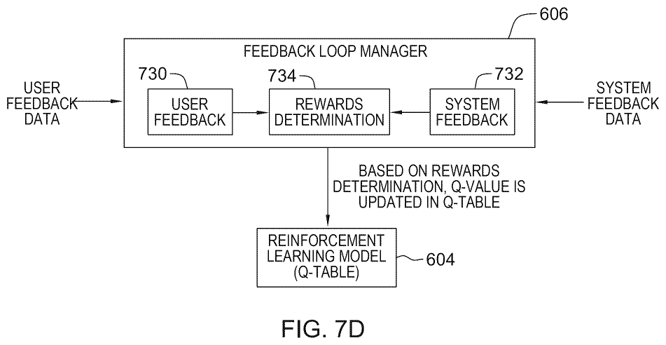

FIG. 7A-7D depict another embodiment of an artificial intelligence system which includes, and/or uses, one or more aspects of the present disclosure. In one or more embodiments, artificial intelligence system 700 is the same as, or similar to, artificial intelligence system 401 of FIG. 4 and implements, for instance, dynamic retrieval granularity control processing that is the same as, or similar to, the dynamic retrieval granularity control process 300 of FIG. 3 and/or the dynamic retrieval granularity control process 600 of FIG. 6, by way of example. As illustrated in FIG. 7A, in one or more embodiments, artificial intelligence system 700 includes, or references, one or more knowledge sources 701 and has a data input normalizer 702 accepting any of a variety of data formats from the one or more knowledge sources. In one embodiment, data input normalizer 702 normalizes the data as per a specified pipeline of the artificial intelligence system. In the illustrated embodiment, artificial intelligence system 700 can include processing to chunk the data into smaller segments 703. As understood, chunking refers to breaking down large amounts of text or other data into smaller, more manageable segments to improve efficiency and relevance in artificial intelligence applications, and in particular, in retrieval-augmented generation. Any of a variety of chunking approaches can be used including, for instance, semantic chunking, recursive with overlap, hard chunking, sentence node parser, etc. The chunks of the data are fed to processing to embed data to capture meaning and context in the chunks of data 704. For instance, data embedding refers to numerical representations of data, such as text, images, audio, etc., that captures meaning and relationships in the data. In one or more embodiments, the artificial intelligence system 700 operates on numerical data, and the embedding translates unstructured chunks of data, such as text data, into a numerical format that the artificial intelligence system can process. Data injection and/or indexing is completed by saving the embedded data chunks to one or more vector databases 705. As understood, the vector database(s) is a specialized database configured to efficiently store and search for vectors, such as used in retrieval-augmented generation.

As disclosed, inference and/or response generation of an artificial intelligence system implementing a hybrid retrieval engine, such as disclosed herein, is enhanced by the provision of a dynamic retrieval granularity control facility with reinforcement learning for the hybrid retrieval engine. Referring collectively to FIGS. 7A-7D, in one or more embodiments, a user system 601 submits a query to query complexity analyzer 602, which evaluates or assesses the complexity of the user query to facilitate determining an optimal retrieval strategy, such as an optimal retrieval depth. For instance, based on the user system submitting a query to the artificial intelligence system, the query complexity analyzer processes the input query and extracts query characteristics, such as query length, keyword density, domain-specific terminology, semantic structure, etc., to determine the complexity of the given query. For multi-faceted queries, the query complexity analyzer can further segment the query into sub-queries (or sub-segments) for better retrieval processing, that is, to enable tailored processing and optimizing of retrieval depth for each individual sub-query. In one or more embodiments, the query complexity analyzer classifies the query complexity, such as into simple, moderate, and complex classes. In one embodiment, a complexity score can be generated that influences the retrieval depth selection by the granularity selector 603 and/or reinforcement learning model 604. The complexity score of the query complexity analyzer 602 is provided to the granularity selector 603 with reinforcement learning 604, which in one or more embodiments, uses the complexity score to proactively, dynamically determine a retrieval depth, and one or more retrieval method parameters, for the retrieval process to be performed by hybrid retrieval engine 605 based on the query.

As illustrated in FIGS. 7A-7B, granularity selector 603 obtains the query complexity and proactively looks for a best retrieval configuration (e.g., retrieval depth and/or other retrieval parameters) for the hybrid retrieval engine 720. In one or more embodiments, granularity selector 603 determines an optimal retrieval process or strategy based on a comprehensive query complexity analysis and one or more recommendations of the reinforcement learning model 722 for forwarding to the hybrid retrieval engine 605. Retrieval parameters, including, for instance, retrieval depth or layers (shallow, intermediate, or deep), process time allocation, and number of documents to be retrieved, can be iteratively adjusted by the granularity selector to ensure precision and efficiency. In one or more embodiments, granularity selector 603 forwards system load data, query complexity data, and any user preference data to reinforcement learning model 604, which returns, in one embodiment, a depth recommendation, and/or other retrieval parameter recommendation, for the query to be processed as desired for a particular application. As noted, in one or more embodiments, reinforcement learning model 604 can leverage Q-values, which are updated based on the user and/or system feedback data, to strike a balance between exploring new retrieval processes and exploiting optimized retrieval processes using an epsilon-greedy policy. In this manner, the reinforcement learning model continually optimizes retrieval selection over time using, for instance, the user feedback and system feedback.

An output of the granularity selector 603 is the optimal retrieval depth and/or retrieval process parameters, such as keyword-based, hybrid-based or semantic-based retrieval processing, and one or more other associated retrieval parameters. As noted, the artificial intelligence system, and in particular, the hybrid retrieval engine 605, is adaptively adjusted or switched between, for instance, keyword-based retrieval processing, semantic-based retrieval processing and hybrid keyword-semantic-based retrieval processing depending, at least in part, on the complexity of the query, using the recommended retrieval depth obtained from the reinforcement learning model. In one or more embodiments, the hybrid retrieval engine executes the retrieval process with the proactively determined and applied retrieval depth and retrieves one or more relevant documents using that retrieval process (e.g., keyword retrieval process, semantic retrieval process or hybrid retrieval process) for the query. As illustrated in FIGS. 7A & 7C, in one or more embodiments, hybrid retrieval engine 605 ranks and filters the results based, for instance, on precision and relevance, and outputs a refined set of the most relevant retrieved documents as the response from the question (or query) answering processing 715. For instance, in one or more embodiments, hybrid retrieval engine 605 accesses, using the determined retrieval depth, one or more vector databases 705 to retrieve chunks of relevant data using retrieval-augmented generation 711, and along with the chunks of retrieved data, forwards the prompt, or query, to a large language model 712 for generating the response to the query, which is provided by the question answering processing 715. As noted, in one or more hybrid-depth retrieval embodiments, hybrid retrieval engine processing can use a staged retrieval process, which employs keyword-based filtering as an initial step to narrow down the search space, followed by deep semantic-based retrieval for enhanced precision. In one or more embodiments, hybrid retrieval engine 605 uses retrieval-augmented generation 711 and large language model (LLM) processing 712 to generate a refined set of the most relevant retrieved documents, which question answering processing 715 uses, or collects, to generate the response back to the user system 601.

In one or more embodiments, a response generation and feedback loop (e.g., feedback loop manager 606 (FIGS. 7A & 7D)), are used to optimize response accuracy and continually improve retrieval performance. As illustrated, in one embodiment, hybrid retrieval engine 605 results are returned to the user system as a response, and the feedback loop manager 606 captures feedback data from the user system and from the artificial intelligence system. For instance, in one embodiment, explicit and/or implicit user feedback data is provided by, or captured from, the user system, such as user click-through rates, user satisfaction score data to a response, user qualitative feedback data, etc., and the system feedback data can include, for instance, process latency data, resource usage data, precision data, etc. The feedback loop manager 606 processes the user feedback data 730 and system feedback data 732 to determine a reward 734 for forwarding to the reinforcement learning model 604. In one implementation, based on the rewards determination, a Q-value can be forwarded by the feedback loop manager 606 to the reinforcement learning model 604 to update a Q-table of the reinforcement learning model. By continually updating the reinforcement learning model, the granularity selector dynamically refines future retrieval depth decisions, such that the artificial intelligence system implements dynamic retrieval granularity control with reinforcement learning that is a continually improving, self-optimizing retrieval process and system. In one or more embodiments, feedback loop manager 606 collects real-time feedback data from either, or both, the user system and the artificial intelligence system. The user feedback data can include, in one or more implementations, explicit or implicit input data, such as user relevancy rating data, user click-through rate data, user time spent on results data, etc. The system feedback data can encompass metrics such as processing latency, resource usage and precision, etc., by way of example. The collective feedback data is processed, in one or more embodiments, into numerical reward data which drives the reinforcement learning updates to continuously optimize the retrieval depth strategies. In one or more embodiments, the feedback loop manager is configured to ensure a balance between system performance metrics and user satisfaction to refine retrieval granularity dynamically.

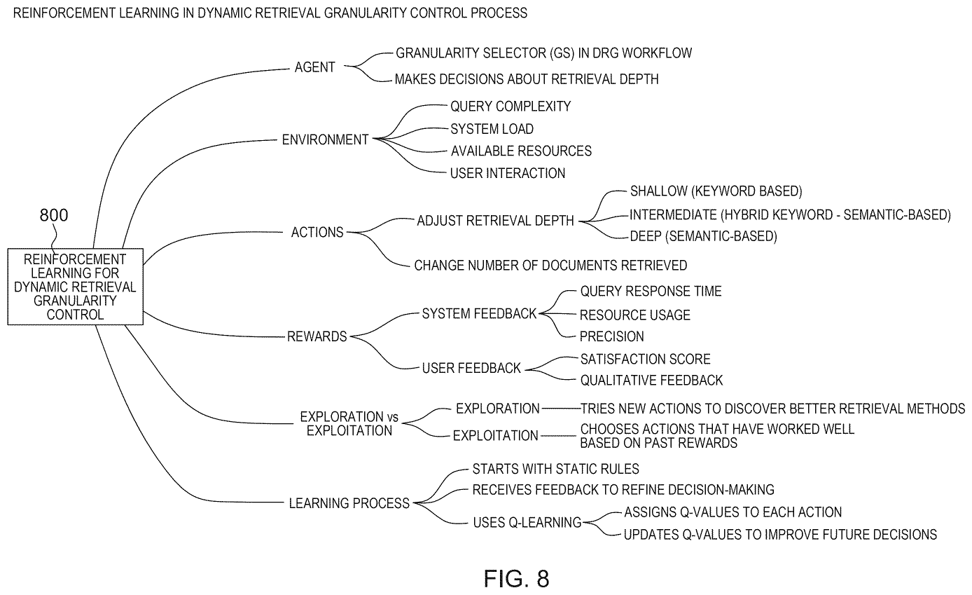

FIG. 8 depicts one embodiment of a reinforcement learning model implementation for a dynamic retrieval granularity control process 800 for a hybrid retrieval engine, in accordance with one or more aspects of the present disclosure. As illustrated, in one aspect, the reinforcement learning model 800, such as reinforcement learning model(s) 418 of FIG. 4 and/or reinforcement learning model 604 of FIGS. 6-7D, is a reinforcement learning model or agent operatively coupled to, or part of, the granularity selector, which facilitates proactively determining retrieval depth for a retrieval process of the hybrid retrieval engine for a given query. In another aspect, the reinforcement learning model or agent considers environmental data for the particular query retrieval process, including, for instance, query complexity data, system load data, available computing resource data, and any user interaction data, such as user preference data, etc. Further, in one or more embodiments, reinforcement learning model or agent 800 performs actions such as initiating adjustment of retrieval depth, for instance, to adjust the hybrid retrieval engine based, at least in part, on the query complexity, to one of a shallow retrieval process, an intermediate retrieval process, or a deep retrieval process, as disclosed herein. Additionally, in one or more embodiments, the reinforcement learning for dynamic retrieval granularity control 800 can include adjusting a number of documents retrieved based on the particular query being processed. In one or more embodiments, the reinforcement learning for dynamic retrieval granularity control 800 further includes continually adjusting rewards based on the results of the retrieval process, including, for instance, based on system feedback data, such as query response time, resource usage, and precision data, as well as user feedback data, such as an explicit user satisfaction score, or other qualitative feedback data. Additionally, in one or more embodiments, reinforcement learning for dynamic retrieval granularity control 800 is configured to balance exploration versus exploitation in recommending a particular retrieval depth, and/or other retrieval parameter, for the retrieval process. As illustrated, exploration attempts new actions to discover better retrieval processes, while exploitation chooses actions that have worked well based on past rewards. Further, as illustrated, reinforcement learning for dynamic retrieval granularity control 800 includes, or implements, in one or more embodiments, a learning process which can, for instance, start with static rules, and receive feedback to refine the decision making of the reinforcement model or agent. In one embodiment, Q-learning can be used where Q-values are assigned to each action, and the Q-values of the reinforcement learning model or agent are dynamically updated, for instance, by the feedback loop manager, to improve future decisions.

As disclosed herein, methods, computer program products, and computer systems are provided which include, or utilize, dynamic retrieval granularity control code and/or processing that proactively configures an artificial intelligence system to dynamically control retrieval granularity of a hybrid retrieval engine (i.e., hybrid retrieval-augmented generation engine) of an artificial intelligence system to optimize retrieval processing for a particular query. As disclosed herein, in one or more embodiments, an adaptive retrieval mechanism is presented that dynamically, proactively adjusts retrieval depth based on real-time query complexity and feedback data. By leveraging reinforcement learning, the artificial intelligence system continuously optimizes retrieval precision, reduces computational overhead, and improves response accuracy. In embodiments, the dynamic retrieval granularity control disclosed addresses prior static retrieval depth issues by dynamically, proactively adjusting retrieval depth using a granularity selector and reinforcement learning. As disclosed, in one or more embodiments, shallow retrieval can be assigned for simple queries, and deeper semantic searches can be assigned for more complex queries. Resource allocation is improved, in one or more embodiments, by the granularity selector optimizing resource use by adjusting parameters, such as time allocation and document retrieval count in real-time, depending on system load and query complexity. Further, response relevance with feedback integration is enhanced by, for instance, continually refining the retrieval process strategies selected using explicit feedback data (e.g., user rating data) and/or implicit feedback metrics (e.g., click through rates and process latency). Additionally, scalability in high load scenarios is improved. By using distributed computing and asynchronous prefetching, the dynamic retrieval granularity control efficiently scales retrieval operations, maintaining performance and relevance during peak usage. In addition, the dynamic retrieval granularity control disclosed balances processing speed and retrieval depth. For instance, the hybrid retrieval engine with proactively set retrieval depth and/or retrieval parameters ensures queries are processed at an optimal depth, balancing speed for simple queries and precision for more complex queries.

An artificial intelligence system is presented which dynamically controls retrieval granularity in a hybrid retrieval-augmented generation engine to optimize information retrieval processing. A reinforcement learning model determines a suitable retrieval depth based at least in part on the complexity of an incoming query. The retrieval depth can correspond to a retrieval strategy, such as keyword-based retrieval, semantic-based retrieval, or a hybrid of both. The system applies the selected retrieval depth to execute the retrieval process, thereby optimizing relevance and performance for the query. Feedback from system metrics and user interaction can be used to update the reinforcement learning model, enabling the system to adapt over time and improve decision-making for future queries. This dynamic control of retrieval behavior allows the system to respond efficiently to a wide range of query types and complexities without requiring manual configuration or static retrieval policies.

The dynamic retrieval granularity control can be applied in a variety of situations. For instance, real-time query optimization for artificial intelligence model development can be enhanced using the dynamic retrieval granularity control disclosed through optimizing retrieval for training methodologies, hyper parameter tuning, and domain-specific implementation details. In another application, adaptive search for data engineering in cloud environments can be enhanced by the dynamic retrieval granularity control disclosed through improvement in operational efficiency for cloud-based pipeline designs by prioritizing practical, resource-specific solutions. In another example, technical support for cloud automation systems can be enhanced by the dynamic retrieval granularity control enabling faster troubleshooting in an automated environment by providing highly targeted solutions, thereby minimizing downtime. In another example, large-scale data analysis and artificial intelligence automation can be enhanced using dynamic retrieval granularity control such as disclosed herein, which can be applied to support large scale data processing in artificial intelligence automation by scaling retrieval operations across multi-cloud environments, ensuring both efficiency and contextual relevance. In one or more embodiments, personalized cloud resource optimization can be provided using dynamic retrieval granularity control such as disclosed. In one or more embodiments, the granularity control enhances efficiency and cloud automation by tailoring retrieval strategies to the specific requirements of users or architects managing the artificial intelligence workloads.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

1. A method comprising:
configuring an artificial intelligence system to dynamically control retrieval granularity of a hybrid retrieval engine of the artificial intelligence system to optimize retrieval processing, the hybrid retrieval engine being a hybrid retrieval-augmented generation (RAG) engine that retrieves, responsive to a query, relevant data from at least one vector database and forwards the retrieved relevant data to a large language model to facilitate generating a response to the query, and wherein the dynamic control of retrieval granularity comprises:
dynamically determining, using a reinforcement machine learning model, a retrieval depth for a retrieval process of the hybrid retrieval engine based on the query to the hybrid retrieval engine, the determining of the retrieval depth being based, at least in part, on complexity of the query to the hybrid retrieval engine and the retrieval depth indicating a retrieval strategy of multiple retrieval strategies; and
dynamically applying the determined retrieval depth to the retrieval process of the hybrid retrieval engine based on the query to optimize information retrieval processing of the hybrid retrieval engine for the query.

2. The method of claim 1, wherein the reinforcement machine learning model continues to learn and adapt in operation from feedback data, including feedback data related to the retrieval process of the hybrid retrieval engine, the reinforcement machine learning model continuing to learn and adapt from the feedback data to optimize a balance between retrieval process speed and information retrieval relevance.

3. The method of claim 2, wherein the feedback data comprises system-generated feedback data based on retrieval processing of the hybrid retrieval engine and user-generated feedback data based on retrieval processing results of the hybrid retrieval engine.

4. The method of claim 3, wherein the dynamic control of retrieval granularity further comprises converting the feedback data into numerical reward data to drive reinforcement learning updates to the reinforcement machine learning model based on the feedback data to refine retrieval granularity dynamically.

5. The method of claim 1, wherein the dynamic control of retrieval granularity further comprises data analyzing, using natural language processing, query characteristics of the query in determining the complexity of the query, the query characteristics being selected from the group consisting of query length, query keyword density and domain-specific terms.

6. The method of claim 1, wherein the dynamic control of retrieval granularity further comprises:
data analyzing the query to determine that the query is multi-faceted; and
based on determining that the query is multi-faceted, segmenting the query into sub-queries and repeating the dynamically determining and the dynamically applying for each sub-query to optimize information retrieval processing of the hybrid retrieval engine for each sub-query.

7. The method of claim 1, wherein dynamically determining the retrieval depth comprises selecting a retrieval depth, using the reinforcement machine learning model, from the group consisting of keyword-based retrieval, semantic-based retrieval, and hybrid keyword-semantic-based retrieval.

8. The method of claim 7, wherein the hybrid keyword-semantic-based retrieval comprises applying keyword-based retrieval filtering followed by semantic-based retrieval filtering in the retrieval process of the hybrid retrieval engine based on the query.

9. The method of claim 1, wherein the dynamic control of retrieval granularity further comprises dynamically configuring multiple retrieval parameters for the retrieval process of the hybrid retrieval engine based on the query, the determined retrieval depth being one retrieval parameter of the multiple retrieval parameters, and wherein the multiple retrieval parameters are selected from the group consisting of retrieval depth, query segmentation, retrieval process time allocation, and number of electronic documents retrieved by the retrieval process.

10. A computer program product comprising:
one or more computer-readable program storage media; and
program instructions stored on the one or more computer-readable storage media to perform operations comprising:
configuring an artificial intelligence system to dynamically control retrieval granularity of a hybrid retrieval engine of the artificial intelligence system to optimize retrieval processing, the hybrid retrieval engine being a hybrid retrieval-augmented generation (RAG) engine that retrieves, responsive to a query, relevant data from at least one vector database and forwards the retrieved relevant data to a large language model to facilitate generating a response to the query, and wherein the dynamic control of retrieval granularity comprises:
dynamically determining, using a reinforcement machine learning model, a retrieval depth for a retrieval process of the hybrid retrieval engine based on the query to the hybrid retrieval engine, the determining of the retrieval depth being based, at least in part, on complexity of the query to the hybrid retrieval engine and the retrieval depth indicating a retrieval strategy of multiple retrieval strategies; and
dynamically applying the determined retrieval depth to the retrieval process of the hybrid retrieval engine based on the query to optimize information retrieval processing of the hybrid retrieval engine for the query.

11. The computer program product of claim 10, wherein the reinforcement machine learning model continues to learn and adapt in operation from feedback data, including feedback data related to the retrieval process of the hybrid retrieval engine, the reinforcement machine learning model continuing to learn and adapt from the feedback data to optimize a balance between retrieval process speed and information retrieval relevance.

12. The computer program product of claim 11, wherein the feedback data comprises system-generated feedback data based on retrieval processing of the hybrid retrieval engine and user-generated feedback data based on retrieval processing results of the hybrid retrieval engine.

13. The computer program product of claim 12, wherein the dynamic control of retrieval granularity further comprises converting the feedback data into numerical reward data to drive reinforcement learning updates to the reinforcement machine learning model based on the feedback data to refine retrieval granularity dynamically.

14. The computer program product of claim 10, wherein dynamically determining the retrieval depth comprises selecting a retrieval depth, using the reinforcement machine learning model, from the group consisting of keyword-based retrieval, semantic-based retrieval, and hybrid keyword-semantic-based retrieval.

15. The computer program product of claim 14, wherein the hybrid keyword-semantic-based retrieval comprises applying keyword-based retrieval filtering followed by semantic-based retrieval filtering in the retrieval process of the hybrid retrieval engine based on the query.

16. The computer program product of claim 10, wherein the dynamic control of retrieval granularity further comprises dynamically configuring multiple retrieval parameters for the retrieval process of the hybrid retrieval engine based on the query, the determined retrieval depth being one retrieval parameter of the multiple retrieval parameters, and wherein the multiple retrieval parameters are selected from the group consisting of retrieval depth, query segmentation, retrieval process time allocation, and number of electronic documents retrieved by the retrieval process.

17. A computer system comprising:
a processor set;
one or more computer-readable storage media; and
program instructions stored on the one or more computer-readable storage media to cause the processor set to perform operations comprising:
configuring an artificial intelligence system to dynamically control retrieval granularity of a hybrid retrieval engine of the artificial intelligence system to optimize retrieval processing, the hybrid retrieval engine being a hybrid retrieval-augmented generation (RAG) engine that retrieves, responsive to a query, relevant data from at least one vector database and forwards the retrieved relevant data to a large language model to facilitate generating a response to the query, and wherein the dynamic control of retrieval granularity comprises:
dynamically determining, using a reinforcement machine learning model, a retrieval depth for a retrieval process of the hybrid retrieval engine based on the query to the hybrid retrieval engine, the determining of the retrieval depth being based, at least in part, on complexity of the query to the hybrid retrieval engine and the retrieval depth indicating a retrieval strategy of multiple retrieval strategies; and
dynamically applying the determined retrieval depth to the retrieval process of the hybrid retrieval engine based on the query to optimize information retrieval processing of the hybrid retrieval engine for the query.

18. The computer system of claim 17, wherein the reinforcement machine learning model continues to learn and adapt in operation from feedback data, including feedback data related to the retrieval process of the hybrid retrieval engine, the reinforcement machine learning model continuing to learn and adapt from the feedback data to optimize a balance between retrieval process speed and information retrieval relevance.

19. The computer system of claim 18, wherein the feedback data comprises system-generated feedback data based on retrieval processing of the hybrid retrieval engine and user-generated feedback data based on retrieval processing results of the hybrid retrieval engine.

20. The computer system of claim 19, wherein the dynamic control of retrieval granularity further comprises converting the feedback data into numerical reward data to drive reinforcement learning updates to the reinforcement machine learning model based on the feedback data to refine retrieval granularity dynamically.
